(19) United States
(12) Patent Application Publication
(10) Pub. No.: US 2009/0119264 A1
(43) Pub. Date: May 7, 2009

(54) METHOD AND SYSTEM OF ACCESSING INFORMATION

(75) Inventors: Brad Bostic, Carmel, IN (US); Chris Lenzo, Carmel, IN (US)

Correspondence Address: STAAS & HALSEY LLP, SUITE 700, 1201 NEW YORK AVENUE, N.W., WASHINGTON, DC, 20005, US

(73) Assignee: ChaCha Search, Inc, Carmel, IN (US)

(21) Appl. No.: 12/265,411

(22) Filed: Nov. 5, 2008

Related U.S. Application Data
(60) Provisional application No. 60/985,445, filed on Nov. 5, 2007.

(51) Int. Cl. G06F 7/06; G06F 17/30

(52) U.S. Cl. 707/3; 707/1; 707/E17.001; 707/E17.014

(57) ABSTRACT

A system and method of associating various communication services with a user ID is described. Using the association of a user ID with various communication service(s) and/or device(s), information related to a search request may be provided via any or all devices and/or communication services which are associated with the user ID.

### CROSS-REFERENCE TO RELATED APPLICATIONS

This application is related to and claims the benefit of U.S. application Ser. No. 11/819,719, entitled “METHOD AND SYSTEM FOR ACCESSING SEARCH SERVICES VIA MESSAGING SERVICES”, by Scott A. Jones, et al., filed on Jun. 28, 2007, U.S. Provisional Application Ser. No. 60/985,445, entitled “METHOD AND SYSTEM FOR UNIFIED ACCESS TO SEARCH RESULTS”, by Brad Bostic, et al., filed Nov. 5, 2007 in the United States Patent and Trademark Office, the disclosure both of which are incorporated herein by reference.

### BACKGROUND

1. Field

The present invention relates, generally, to information search systems, and more specifically, to information search systems in which a search system utilizing human searcher(s) may provide search results to information seeker(s) using messaging services, and/or a voice service. In particular, a process and system of submitting a search request and/or receiving a search result(s) using one or more communication services.

2. Description of the Related Art

Search systems have been developed which allow a user to submit a search query using a web-based interface. Recently search systems have been developed which allow a user to submit a query using a voice interface, an Instant Messaging (IM) interface, an email interface, and a messaging service.

Some users may obtain a more customized search service by creating an individual login, which may be associated with other services offered by search service providers. For example, Yahoo®, or Google® provide email, and/or other services in combination with search services if a user creates a login identifier (ID) and a password, which may be shared with other services. A user ID associated with an account may allow a person to access web-based functions from any device which is able to access a server associated with the account.

However, if a user submits a search request using a device and/or service such as IM Simple Messaging Service (SMS), Enhanced Messaging Service (EMS), Multimedia Messaging Service (MMS), email, voice, etc. there is no known way for a user to access a search result(s) and/or other information related to the search request using other services which may be associated with the user.

### SUMMARY

The disclosed system and method includes providing access to information by associating a first identifier with a second identifier and providing information of a message associated with the first identifier using a service associated with the second identifier.

The disclosed method includes receiving a search request associated with a telephone number, associating the telephone number with a login identifier provided by a user, and providing information of the search request to the user using a web page associated with the login identifier.

The disclosed method and system includes receiving a request using a first communication type and conducting a search responsive to the request and providing information resulting from the search using a second communication type.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Aspects and advantages of the invention will become apparent and more readily appreciated from the following description of the embodiments, taken in conjunction with the accompanying drawings, of which:

FIG. 1 is a diagram of a system embodiment.

FIG. 2 is an illustration of a messaging GUI,

FIG. 3 is a diagram of an alternate system embodiment.

FIG. 4 is a diagram of an alternate system embodiment.

FIG. 5 is a flow chart of a process of performing a search.

FIG. 6 is a flow chart of a process of performing a search.

FIG. 7 is an illustration of a database relationship.

FIG. 8 is a flow chart of a process of performing a search.

FIG. 9 is a flow chart of a process of performing a search.

FIG. 10 is a flow chart of a process of performing a search.

FIG. 11 is a flow chart of a process of associating a user identifier with other user identifiers.

FIG. 12 illustrates a graphical user interface (GUI) for user registration.

FIG. 13 illustrates a GUI for conducting a search as a logged-in user.

FIG. 14 illustrates a GUI for reviewing an identifier(s) associated with a user ID.

FIG. 15 illustrates a GUI for associating an identifier(s) with a user ID.

FIG. 16 illustrates a GUI for managing user information.

FIG. 17 illustrates a GUI for review of historical information.

FIG. 18 illustrates a GUI for review of historical information.

FIG. 19 illustrates a user record.

FIG. 20 is a flowchart of associating a communication service with a user query.

FIG. 21 illustrates a GUI for associating a communication service with a user query.

### DETAILED DESCRIPTION OF THE PREFERRED EMBODIMENTS

Reference will now be made in detail to the embodiments described herein, examples of which are illustrated in the accompanying drawings, wherein like reference numerals refer to like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. A method and system for submitting a search request and/or receiving a search result(s) using one or more types of communication services is disclosed. One or more communication services may be associated with a unique identifier of a user. A user may receive a message(s) from a search system utilizing any communication service associated with a user identifier. A user may access information provided by a search system using any communication service associated with an identifier of a user.

A user is provided with the ability to submit a query to a search system using various communication service(s). A user may designate two or more identifiers of a communication service(s) which may be used to submit and/or access a search request(s), a search result(s) and/or any information associated with a search request(s) using the communication service(s).

An interface is provided whereby a user may access search service(s) using Instant Messaging (IM). An IM client may communicate through an IM service provider to an IM messaging application which may be hosted on a server associated with a search service which delivers a search request(s) to a server of the search service. The search service may provide a search result(s) and/or other information to a user via an Instant Message by transmitting a message via an IM messaging application through an IM service provider to a user IM client.

An interface is provided whereby a user may access search services using email. An email client may communicate through an email service provider to an email messaging application which may be hosted on a server associated with a search service which delivers a search request(s) to a server of the search service. The search service may provide a search result(s) and/or other information to a user via an email message by transmitting a message via an email messaging application through an email service provider to a user email client.

An interface is provided whereby a user may access search services using SMS, EMS, MMS, and/or other mobile messaging services. A messaging client may communicate through a mobile messaging service provider to a mobile messaging application which may be hosted on a server associated with a search service which delivers a search request(s) to a server of the search service. The search service may provide a search result(s) and/or other information to a user via a mobile message by transmitting a message via a mobile messaging application through a mobile messaging service provider to a user mobile messaging client.

An interface is provided whereby a user may access search services using a voice service. A user may communicate through a voice service provider to a text to speech and/or transcription service which may be hosted on a server associated with a search service which delivers a search request(s) to a server of the search service. The search service may provide a search result(s) and/or other information to a user via voice message by transmitting a message via a text to speech application through a voice service provider to a user device.

A user may create a login ID which may allow a user to access information of a search request(s), a search result(s) and/or other information associated with the search request(s) submitted by the user using a web based interface. If the user elects to associate a first identifier of a communication service with a second identifier of a communication service, the user may be provided with information of a search request(s), a search result(s), and/or other information which are associated with the first and/or second identifier when requested using the first and/or second communication service(s).

An identifier of a user such as a land line phone number, a mobile phone number(s), an IM credential(s), an email addressees), a user login, or any other communication service(s) may be associated with a user identifier (ID). While examples of identifiers of a user are provided, the present invention is not limited to any particular identifier of a user and may include any data using which a user can be identified. The association of a user ID may allow a user to review a search result(s), search query(ies), searcher(s) and/or other information provided in response to a search query or search request or query submitted using one communication service(s) associated with a user ID.

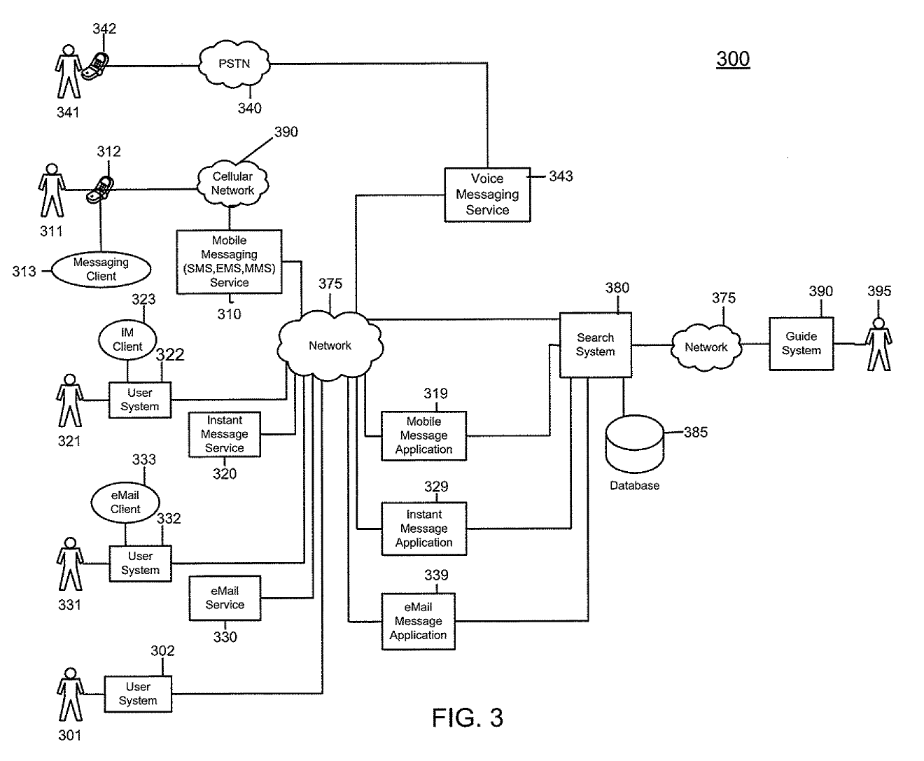

A user or information seeker using a chat or instant message type of interface can access search services via an instant message or ‘chat’ type service, for example, the America Online® Instant Messenger™ (AIM®) service. An instant message service connects a user to an application associated with an information search system that allows a user to utilize an IM interface to access a service(s) provided by the information search system. If a connection is established by a user and the search system, an instant message including a search request may be transmitted by a user to the search system. A query can be determined from an instant message and passed to a search system, which can respond with a search result(s) and/or other information using Instant Messaging as described further herein below with respect to FIG. 3.

A user or information seeker using an email type of interface can access search services via an email service provider, for example, Gmail®. An email message service connects a user to an application associated with an information search system that allows a user to utilize an email service interface to access a service(s) provided by the information search system. If a connection is established to an email service an email message including a search request may be transmitted by a user to a search system. A query can be determined from an email message and passed to a search system, which can respond with a search results and/or other information using an email message as described further herein below with respect to FIG. 3.

A user or information seeker using a mobile messaging type of interface can access search services via a mobile message service provider(s), for example, Verizon®, Cingular®, Mblox®, etc.. A mobile message service connects a user to an application associated with an information search system that allows a user to utilize a mobile message service interface to access a service(s) provided by the information search system. If a connection is established to a mobile message service a mobile message including a search request may be transmitted by a user to a search system. A query can be determined from a mobile message and passed to a search system, which can respond with a search result(s) and/or other information using mobile messaging as described further herein below with respect to FIG. 3.

A user or information seeker using a voice connection can access search services via a voice service provider(s), for example, Verizon®, AT&T®, or Skype®. A voice connection may be established between a user and a search system using text-to-speech and speech-to-text capabilities. A user query may be converted from speech to text, and transmitted to a search system. A search system may respond using text to speech conversion. A search system may respond with an automated response. A search result(s) produced by a human searcher may be converted from text to speech. A user, also referred to as an information seeker may be any person. A human searcher or guide or searcher may be a paid searcher and/or a volunteer. A search query or search request or query may be submitted using any device(s) and/or communication service(s) which may access the search system using the service(s). A search result(s) or result(s) may be provided to a user via any device(s) and/or communication service(s) associated with a user.

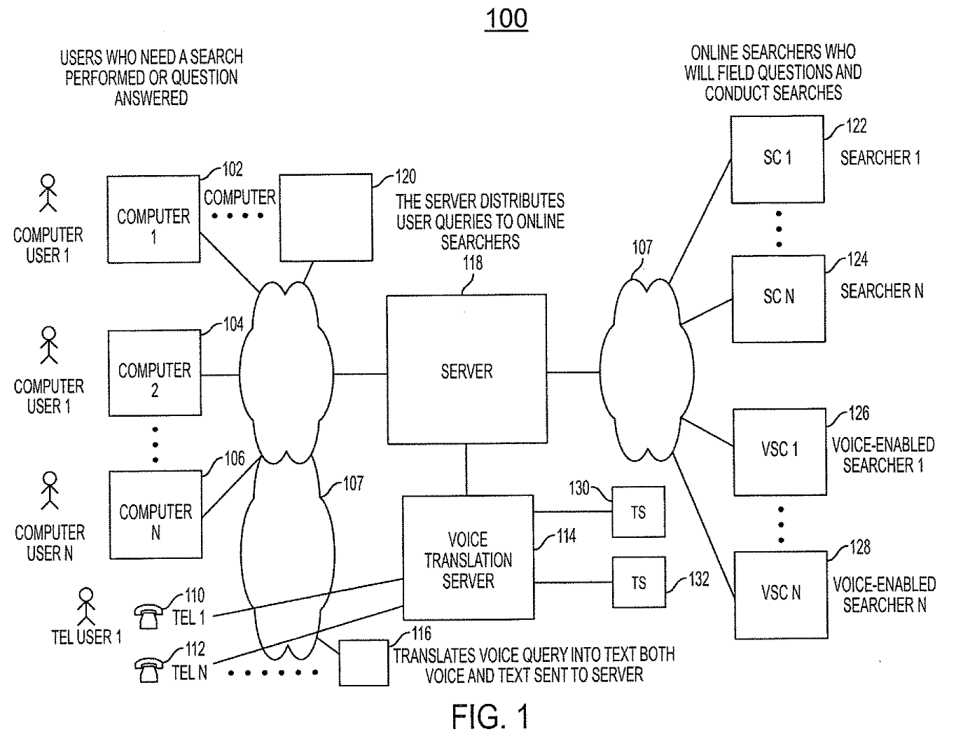

As illustrated in FIG. 1, guides or searchers using SC1 122, for example, are humans who perform an information search responsive to a query(ies). A query or search request may be submitted by a user or requester, for example, an information seeker using the user system computer1 102. An information query may be processed as described in the related application U.S. application Ser. No. 11/336,928, filed Jan. 23, 2006, by Scott A. Jones, entitled, “A Scalable Search System Using Human Searchers,” the content of which is incorporated herein by reference in its entirety.

The embodiments described herein include a system 100 that allows queries by users or information seekers (InfoSeekers™), such as a worker, a housewife or a child, to be searched by human searchers to provide the information seekers with search results. The human searchers or guides may be professional paid searchers (PaidSearchers™) as well as amateur and/or volunteer searchers. For example, a query (which, throughout this description, may entail a fully-formed question/sentence or a keyword or a list of keywords or a search phrase as previously discussed) might request, for example, the closing time of a particular restaurant, the winner of the 1960 World Series, or information regarding a medical illness (or any other type of query). As depicted in FIG. 1, the queries can originate from user computer systems 102, 104, 106 and are received over a communication system 107 or from telephone handsets 110, 112. The user computer systems can be a typical desktop or laptop system, a handheld computer such as a personal digital assistant (PDA), a basic cellular telephone, a text-enabled cellular telephone, a specialized query terminal, or any other source that allows a user to enter a query. (NOTE: the words “speech” and “voice” are used interchangeably in this discussion). The telephone handsets can be typical touch-tone telephones, cellular telephones, two-way radios or any other communication device that allows the user to communicate over a distance. The communication system can include packet switched facilities, such as the Internet, circuit switched facilities, such as the public switched telephone network (PSTN), radio based facilities, such as a wireless network, etc.

The speech queries submitted by telephones 110, 112 are stored in the system database and converted into digital text queries by a speech (voice) translation server 114. (Alternatively, the user's computer 102, 104, 106 or telephones 110, 112 may perform this processing). The speech translation server 114 handles the task of translating the speech into text, possibly by interaction with other systems, or it may perform the task locally. It may perform speech to text conversion via speech transcription using human transcribers and/or using conventional speech-to-text processing, also known as automatic speech recognition (ASR). The speech queries may originate from a user's telephone and can be initially handled via automated attendant speech prompt type processing (or alternatively, via an interactive speech response or IVR system) to obtain the user's query.

The speech translation server 114 keeps track of the port from which a call originates and assigns a user identifier to the user 110, 112 on this port for a particular session. The speech translation server 114 can prompt the user to speak the query. The speech queries can also originate from another source 116 called a “speech query service requester” (SQSR) rather than directly from the user, such as a private or public information provider. For example, a speech query can be initially processed by a public library telephone system and switched to the speech translation server 114. The speech query may physically arrive at the system via a variety of input channels, such as time-division multiplexed lines, voice over IP (VoIP) packets from an Internet connection, or other sources. The speech query may arrive as a stream or packet or series of packets.

Similarly, a commercial site, such as a grocery store ordering system where a user orders food and inquires about recipes for a special after-dinner dessert can initially process a speech query and pass it along to the speech translation server 114.

The SQSR 116 may communicate with the speech translation server 114 via a variety of mechanisms including an IP-based socket address or via a Microsoft® .NET service, making the translation services of 114 widely available via the Internet to any application that wishes to use them.

The packet can then be processed locally at the speech translation server 114 to convert it from digitized speech into text or, alternatively, it may be processed by a remote system. If the digitized speech is being transcribed by human transcribers, this can be accomplished by sending the digitized speech to one or more transcriber systems (TS) 130, 132 where human transcribers can hear speech, for example via headphones or speakers, and may transcribe the information by typing the text into their system, so that the text is then sent back to the speech translation server 114 (or alternatively, directly to the query server 118 or to the SQSR 116), all within a matter of seconds (preferably less than 10 seconds after the user has finished speaking the query). To speed up processing, a speech query can be and typically is preferably broken up into a stream of packets and passed to the transcriber, without interruption, as it is being spoken by a user, thereby allowing for reduced latency in the system. Preferably, there are many more transcribers available in the system than there are instantaneous queries so that delays are not induced into the system. In the case of an overflow of queries, a form of flow control may be utilized by telling some callers that they must hold on the line for an available transcriber (which might be described to the caller as holding for an operator or agent). Preferably, the speech translation server 114 maintains a database of all transcribers that are currently logged-in and available to perform the service of transcription using a transcription software application on transcription systems 130, 132. Alternatively, this function of tracking the availability of transcribers might be located on a remote system and/or might be implemented using a distributed mechanism among transcriber systems 130, 132 (for example, using peer-to-peer (P2P) mechanisms).

The speech translation server 114 may feed continuous sequential speech phrases from various and different sources (e.g., users) to any given transcriber 130. Hence, the transcriber may be sequentially transcribing, in rapid succession, speech messages from various speakers and creating separate text packets that are associated with each speech message.

Once the query is in digital text form, it is provided to the query server 118. The text entry features of cellular telephones can also be used to enter a query in digital text form allowing users to submit queries textually from telephones.

Queries from a graphical user interface (GUI) of the user computers 102, 104, 106 can originate directly from the user, or like the speech queries, indirectly through a TQSR (Text Query Service Requestor) 120, which may be any software application or device connected via the Internet, for example. As in the speech query, a user may be on a grocery store web site ordering food for delivery and may inquire about a recipe for a special dessert. This recipe query would be forwarded to the query server 118. Any web site, software application, consumer electronics device, or other device may become a TQSR or SQSR for performing a search. For example, a set top box offered by a satellite TV or Cable TV provider could offer the ability to enter a query string and act as a TQSR or SQSR. Any software application running on a PC, such as Microsoft® Office Word or Excel®, may also serve as a TQSR or SQSR.

An appropriate interface, such as a graphical user interface (GUI) for user computer 102 or speech prompt system in the speech translation server 114 may extract a query from a user and transmit the query to the query server 118.

Upon the receipt of a query, such as from user computer 102 in this example, the query server 118 can provide information (e.g., advertisement(s)) to a user for the user to see and/or hear while the search is being processed. This information can be related to the query (or to the keywords of the query) and may include visual and audio information as appropriate for the user's device and for the source of the query, such as a grocery store ad in the recipe example. This information can include not only advertisements, but also information such as video, music, games, web links, etc. that may interact with and/or display for a user while the search is being performed. The information provided may serve as a source of revenue, for example through advertising. If a user views an ad, or clicks on a link, or purchases a product (sometimes referred to as “conversion”) related to an advertisement while awaiting results of a search, the database can be updated to reflect additional ad revenue with a credit of some sort to a searcher. A digital text, graphics, audio, or video advertisement may be displayed (or played) on a user computer 102 a user telephone 112 or other user device. A particular advertisement selected is or can be based on a weight associated with the advertisement based on single or combined factors such as advertiser contract commitments, bidding price of advertisers, popularity with users, keyword mapping to advertisements, statistical usage (e.g., least recently presented), user demographics, searcher choice of advertisement, etc.

The server 118 processes arriving queries by determining which searcher(s) are available to search for the information being requested, based upon factors such as a searcher being logged-in, searchers who are signed-up for a keyword, or category, and/or the ranking of a searcher based on previous performance.

The server 118 may also determine if a particular query has been received previously and may send a response to the user with previously obtained search results without necessarily invoking a human searcher.

When no previous query results satisfying or that may satisfy a query are available, the server 118 may send the query to one or more available searcher(s) over the communication system 107. If a query is a speech query, in addition to sending the text version of the query and the keyword(s), a speech recording of the query can be transmitted. The human searcher(s) can be located at computer-based searcher tool systems 122, 124 speech-enabled computer-based searcher systems 126, 128, and/or other suitable searcher (guide or provider) systems.

A server-chosen searcher (or searchers) reviews a query, including the keyword(s) and any speech recording and decides whether to accept the search task. When a searcher accepts the search task, this acceptance may be communicated back to a user who originated a query through the server 118. This may happen automatically or manually. Because some searches may require additional information or clarification, the searcher can send a request for additional information to the user. This may be sent through server 118 or via direct link to a user via the communication system 107. The user replies with a clarification, additional information and/or a revised query. The searcher(s) then uses the searcher tool system 122, 124, 126, 128 to perform a search of publicly or privately available information to produce search results. For example, a searcher may use conventional tools, such as a browser, to access public databases via searches over the World Wide Web or private databases that may be accessible only to the searcher, such as a database of information previously gathered by a searcher, or from results stored on the query server 118 from other searchers, or from databases that require payment for access or even information available to the searcher in non-electronic form, such as a book on a searcher's bookshelf, test results from a personal experiment, etc. A searcher may also submit the search query, or some version of it to an automated search tool such as the Google® or Ask Jeeves® systems. The search results, such as an answer, comments by a searcher, web pages, web links, and other query related information, etc. are gathered by a searcher during a search. The result(s) of a search, such as web pages and links which a user can review or use to obtain the information desired, an answer to a question and web pages or links to web pages that support the answer, etc., can be transmitted back to the user through the server 118 or directly to the user via the communications system 107. The information returned is typically what the searcher thinks or intends can satisfy the need of a user. The information may include anything that might satisfy the user, including a document, a video, a song, a configuration file, pictures, links, etc.

The result(s) are presented to a user in real-time, constrained by the amount of time it takes to find a searcher and do the search. Available searcher(s) are preferably identified within one to fifteen seconds and a searcher preferably begins the work of performing the search within one to fifteen seconds. Depending on the search, the accumulation of relevant results may generally take from a few seconds to a few minutes. The server 118 or search tool may interact with a user automatically every approximately six seconds via the chat session (or via the VoIP connection) in order to signify to the user that progress is being made. This might be as simple as a dot typed on a user's screen or a more detailed automated message. When on a telephone, a user will preferably be hearing and/or watching an advertisement(s), but during silent periods, user interaction may occur via speech such as having a searcher or an automated speech system say, “Please continue to hold while your search is being performed”. A searcher may interact with a user, either of his or her own accord or the searcher tool may remind the searcher to give status to the user. A searcher may also send partial results to a user so that the user may begin to preview results. The server 118 stores the query phrase and the search results for matching with future queries.

A message may be provided to a user by conversion of text to speech. For example a user such as telephone user 1 located at the telephone 110 may receive a search result(s), an advertisement(s), a clarification request(s), etc. as an audio message. Such an audio message may be produced by conversion of text to speech. Text to speech conversion may be performed in various ways. For example, automated text to speech software operative on the voice translation server 114, the server 118, the text query service requestor 120, the SQSR 116, or any other suitable device may provide an audio message to a user. For example, a search result(s) associated with a previously answered query(ies) may be transmitted to a searcher located at a voice enabled searcher computer such as the computer system 126, and the searcher may provide an audio response to a user such as the user located at the telephone 110. Alternately, a searcher such as searcher 1 located at the searcher computer system 122 may input text which may be converted to speech and transmitted to a user such as telephone user 1 located at the telephone 110. A text to speech application or a person may be utilized to provide a speech or voice message to a user at a device such as the user computer systems 102, 104, 106, or at a user device such as the telephones 110, 112.

In at least one embodiment, a user, for example, an information seeker using computer 102 can chat with a search system. In particular, the search system appears to the information seeker as another chatter or buddy. As a result, the information seeker using computer 102 can chat with a guide using computer 122 via the server 118, as will be described in more detail herein below.

As illustrated in FIG. 3, the chat client 323 can be located on a system of an information seeker such as the user system 322. An information seeker may utilize a chat or instant message session to obtain search results in response to a user query according to the embodiments described herein. A user(s) can utilize the functionality provided by a chat service or an instant message service, for example AIM®, MSN® Messenger, Google Talk™, etc. To access search services by using such a chat or an instant message service interface, a connection using the instant message client 323 may be established with the Instant Messaging service 320. The search system 380 logs into the instant message service 320 via the Instant Messaging application 329 and is registered as an online buddy or buddies on the IM service 320.

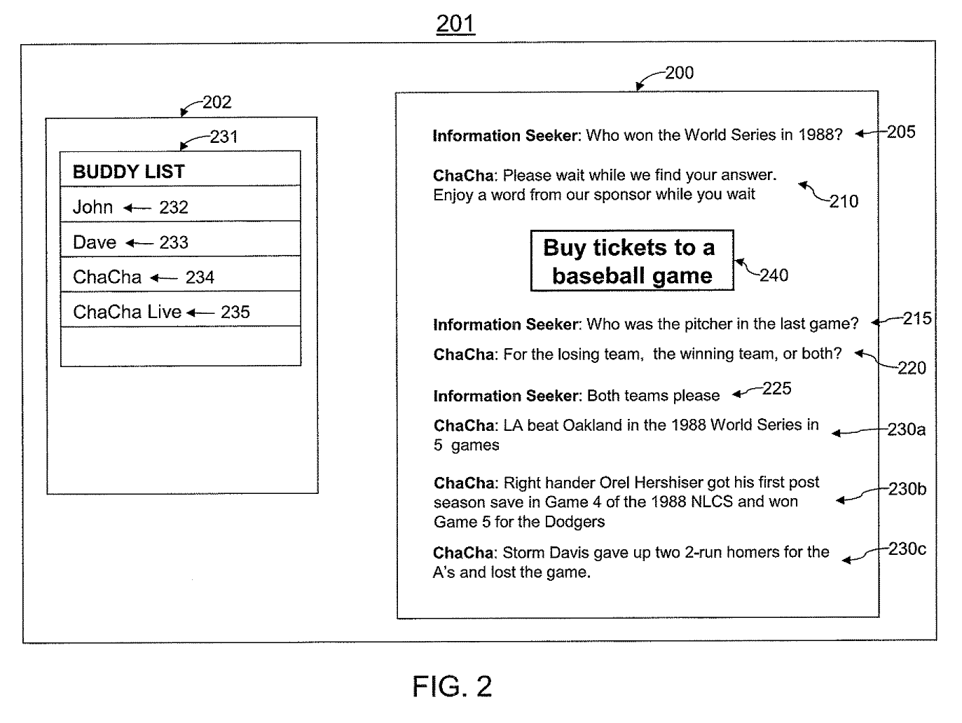

When a user at, for example, user computer 322, logs into a system that provides an instant messaging (IM) service such as the IM service 320, the user may be presented with a window 201 (FIG. 2) or Graphical User Interface (GUI) that includes the buddy list frame 202 and the conversation window 200. The GUI 201 may include a buddy list 231. The buddy list 231 may include buddy indicators such as the ‘John’ buddy indicator 232, and the ‘Dave’ buddy indicator 233. The ‘ChaCha’ buddy indicator 234 and the ‘ChaCha Live’ buddy indicator 235 may be present in the buddy list 231 if the search system 380 has established an IM connection to the IM service 320. If a user selects the ‘ChaCha’ buddy indicator 234, a chat session for a search which may not utilize the assistance of a human searcher may be opened. Similarly, when a user selects the ‘ChaCha Live’ buddy indicator 235, a chat session for a search which may utilize the assistance of a human searcher may be opened. In at least one embodiment, a single buddy indicator associated with the search system 380 may be provided. In at least one embodiment, more than two buddy indicators associated with the search system 380 may be provided.

The search system 380 which may include and/or access the database 385 (FIG. 3) may be configured to allow anonymous communication between a user and a searcher(s) and reconnection between a user and a searcher(s) during follow-up communications. An exemplary system for anonymous communication is described in U.S. application Ser. No. 11/779,502, entitled, “Anonymous Search System Using Human Searchers,” filed Jul. 18, 2007, by Scott A. Jones et al., attorney docket 1918.1006., the disclosure of which is included herein by reference in its entirety. The database 385 may include various records. The database 385 can include IM credentials associated with a chat buddy representing a general interface to a search system including a human searcher, IM credentials associated with the ‘ChaCha’ search buddy indicator 234 and/or IM credentials associated with the ‘ChaCha Live’ search buddy indicator 235. The database 385 can include an online status indicator indicating whether a chat buddy identified by a buddy list identifier is currently busy. For example, if a selected guide is responding to a query, or if the search 380 system is locating a suitable guide, the ‘ChaCha Live’ search buddy indicator 235 may specify “busy” to an information seeker thereby informing the information seeker of the need to wait until the guide search buddy is unoccupied. The database 385 may contain a unique user ID which is associated with an IM credential(s), email address(es), phone number(s), IP address, and/or other identifier(s) of a user who initiates a query.

A messaging based search session such as the IM session illustrated in FIG. 2 can begin by an information seeker initiating or posting a “chat” search query to for example the ‘ChaCha’ buddy 234 identified in the GUI 201. As illustrated, an information seeker enters or posts the search query 205, “Who won the World Series in 1988?” The search system 380 (FIG. 3) can respond with the system message 210. The search system 380 may provide a hyperlink, an image, and/or other information pertaining to a product and/or service in the advertising window 240. Information can be displayed to a user directly in the case where the user has a simple IM interface, or could trigger secondary display of the URL, or other information within a web page which contains an embedded chat interface, such as Web AIM™. Likewise the search system 380 may send images, audio, and/or video or any other media which is supported by the IM client 323.

It should be noted that at any time, an information seeker may submit or post additional query strings and/or other information, via the chat interface. For example, as illustrated in FIG. 2, an information seeker can enter the query message 215 in which the information seeker indicates that he or she would like to know “who was pitching in the last game?”

It may be determined by the search system 380 and/or a searcher that a query is ambiguous. Using the example illustrated, at least two pitchers pitched in the baseball game, that is, a player from the losing team and a player from the winning team. Not knowing whether the information seeker intended to obtain information regarding the losing team pitcher, the winning team pitcher, or both of the pitchers, the response message 220 can be sent seeking clarification of the question presented in the query message 215. The information seeker can provide the clarification response message 225, for example, in this case indicating the desire to obtain information regarding both pitchers in the baseball game. A search results can be provided to the information seeker in the system response messages 230a, 230b, and 230c as illustrated in FIG. 2.

The query messages and response messages may not be produced in the order depicted in FIG. 2. For example, the response message 230a might be provided before the query message 215 is received. The search database 385 includes records which may allow the search system 380 to provide a search result(s) to a user(s) which may be based on previously stored information and/or a search result(s) produced by a search by a guide responsive to a user request(s). Any or all of the response messages 230 may be provided by a guide and/or by the search system 380 based on stored information.

While the query and search result messages have been illustrated using the example of an IM interface and GUI, no limitation is implied thereby. For example, any or all query messages might be sent using SMS, EMS, MMS, email, voice, IM, VoIP, internet and/or other communication service(s). Likewise any response messages from the search system 380 and/or a guide may be sent using SMS, EMS, MMS, email, voice, IM, VoIP, internet and/or other communication service(s). A system for providing an interface to the various communication services is described further herein below with respect to FIG. 3.

FIG. 3 depicts an embodiment of a system 300 comprising a messaging interface(s) to a search system. The system 300 may include at least one human searcher (or guide) 395 who can use a guide system 390 to perform a search for information using resources accessible via the network 375 and/or other information accessible to the guide, as described herein above. Users such as user 301 may send queries to the search system 380 using the user system 302 via the network 375. A user such as the user 341 may submit spoken search queries to the search system 380 using the telephone 342 via the (PSTN) 340 and the voice messaging service 343, such as a voice translation server, which may provide speech to text and text to speech services. As will be described below, users (or requesters) 311, 321, 331 may be able to use messaging technologies to interact with the search system 380. While a single guide and a single guide system are depicted in FIG. 3, it is envisioned that multiple guides and multiple guide systems may be utilized.

As illustrated in FIG. 3, at least one instant message application 329 is provided. The instant message application 329 connects with the instant message service 320 via the network 375. The network 375 may be a global public network of networks (the Internet) or consist in whole or in part of one or more private networks. It should be noted that the search system 380, the IM chat service 320, and the instant message application 329 are communicatively coupled via the network 375.

The instant message application 329 serves as a programmatic instant message client that simulates a user IM client which implements a communication protocol associated with the IM service 320, thereby appearing to the user 321, for example, as a chat buddy. The user system 322 includes the instant messenger client 323 that communicates with the instant message application 329, via the instant messaging service 320.

The search system 380 receives notification via the instant message application 329 from the IM service 320 that the user 321 at the user system 322 desires to send a search request or query to the search system 380 which appears to the user 321 as a chat buddy. Since the instant message application 329 contains the necessary code to implement the communication protocol associated with the instant message service 320, the user system 322 may send a message(s) to the IM application 329 which may process the message(s) and send a search request to the search system 380. Likewise a message from the search system 380 may be processed by the IM application 329 and a message may be transmitted to the user system 322 via the network 375 and the IM service 320.

It should be noted that the instant message application 329 can be operative on an application server, a server associated with the IM service 320 and/or a server associated with the search system 380. After being presented with the disclosure herein, one of ordinary skill in the relevant art will realize that the IM application 329 may be located on any system which can provide a suitable interface to the instant message service 320. The search system 380 and the IM service 320 may include one or more servers such as those provided by Dell, HP, or other similar providers and may be implemented using any operating system such as Windows®, Linux, etc.

While the IM application 329 is illustrated in FIG. 3 as being connected to a single instant message service 320, multiple IM application processes which may connect to various IM services such as AIM®, Google Talk™, MSN® Messenger, etc. can be implemented in order to allow users of any IM service to access the search system 380. As a user may be identified by IM credentials associated with the user, which may be provided to an IM service from any device which may have an IM client operative on it, the IM credentials may be used as a unique identifier of the user. IM credentials may be used as a persistent identifier of a user and may be used to allow a user to access information regarding a search request(s), a search result(s), and/or other information associated with the IM credentials.

A user may elect to access a service(s) of the search system 380 using the email service 330 and/or the mobile messaging (SMS, EMS and MMS) service 310. In order to provide services to such users, it is necessary for the search system 380 to be able to appear as a valid email address to the email service 330 and/or a terminating point such as a short code or mobile telephone number to the mobile messaging service 310. This capability can be provided using the email message application 339 and the mobile message application 319, respectively.

The email message application 339 allows a user to send a search request(s) as an email message(s) to an email address associated with the search system 380 and receive a response(s) from the search system 380 as an email message(s) from an email address associated with the search system 380. The user 331 is able to send email messages via the email client 333 which may be operative on the user system 332, or on a server associated with the email service 330 or on any suitable device that allows a user to access the email service 330. Messages may be transmitted in SMTP, ESMTP, or other formats, and can be received using POP or other mail protocols. The email message application 339 may process a message. For example, content of a query may, for example, be extracted from the subject line and/or the body of the email message. The email message application 339 may manage attached files, and the forwarding of attachments to the search system 380.

The email message application 339 may implement a programmatic client which may access the email service 330 in order to login to the email service 330 and send and receive messages sent to a particular email address, for example “searchchacha@chacha.com” which is associated with the search system 380.

The email message application 339 may for example allow the use of standard query templates which can be used to construct query strings. For example, a standard title could be used to identify each type of query template. A user or information seeker may be presented with an HTML form using a mail client which might assist the user to send a query to the search system 380. A structured query based on the email template may facilitate an automated response by the search system 380 and/or may allow more effective selection of a suitable guide(s). The email message application 339 may perform any suitable processing of an email message which may provide information to the search system 380.

Any response by the search system 380 such as a request for clarification, a search result(s), an advertisement(s), etc. may be received by the email message application 339. The email message application 339 can process the message and transmit an email message to a user email address via the email service 330. The search system 380 may associate a unique user ID with the email address of a message received from a user. The unique ID can be stored in the database 385 along with the user email address. This may allow the search system 380 to identify previous queries, etc. when a user connects to the search system 380. An email address may be used as a persistent identifier of a user and may be used to allow a user to access information regarding a search request(s), a search result(s), and/or other information associated with the email address.

The email message application 339, the search system 380, and the email service 330 are communicatively coupled by the network 375 which enable a human searcher(s) and/or the search system 380 to provide a response(s) to an email message which includes a search query submitted by an information seeker via the email service 330. While a single email service, a single email message application and a single email client are depicted in FIG. 3 it is envisioned that any number of email services, email message applications and email clients may be provided as required to allow a user(s) to access services of the search system 380.

In addition to email and IM access a user such as the user 311, may desire to access a service(s) of the search system 380 using mobile messaging technologies, such as SMS, EMS, and MMS. Mobile messaging services can be provided using a wireless network such as the wireless network 390, the messaging client 313 which may be resident on the user mobile device 312, the mobile messaging service 310, and the mobile message application 319. The wireless network may be implemented using FDMA, GSM. GPRS, CDMA, WDMA, WiFi, WiMax, and/or other wireless protocols.

The mobile message application 319 provides similar functionality as the IM application 329. For example, user 311 may use the messaging client 313 to send a suitably formatted message to the mobile messaging service 310 via the wireless network 390. The messaging client 313 may be operative on the user mobile device 312. The user mobile device 312 may be any device which may access a wireless network such as a smart phone, a text enabled cell phone, a PDA, a portable PC, a media player, etc., which may be connected via any wireless protocol. Message can then be sent by the mobile messaging service 310 to the mobile message application 319 via the network 375. The mobile message application 319 may appear as a phone number or short code to the mobile messaging service 310. The mobile message application 319 receives a message and parses the message in order to create a suitable query for the search system 380, based on the format of the received mobile message. The mobile message application 319 may send data such as the caller ID and/or other information associated with the user 311 and/or the user mobile device 312 to the search system 380.

A response(s) from the search system 380 may be routed back to the user mobile device 312 via the mobile message application 319. The mobile message application 319 receives a response message(s) from the search system 380. The mobile message application 319 processes the response(s) from the search system to create a response mobile message(s) which is transmitted to the mobile messaging service 310. The mobile message service 310 may then transmit the response mobile message(s) to the user mobile device 312. The search system 380 may associate a unique user ID with a phone number of a message received from a user. That unique user ID can be stored in the database 385 along with the user phone number, which may allow the search system 380 to identify previous queries, etc. when a user connects to the search system 380. A telephone number may be used as a persistent identifier of a user and may be used to allow a user to access information regarding a search request(s), a search result(s), and/or other information associated with the telephone number.

While a single mobile message service, a single mobile message application and a single messaging client are depicted in FIG. 3 it is envisioned that any number of mobile messaging services, mobile message applications and mobile message clients may be provided as required to allow a user(s) to access services of the search system 380.

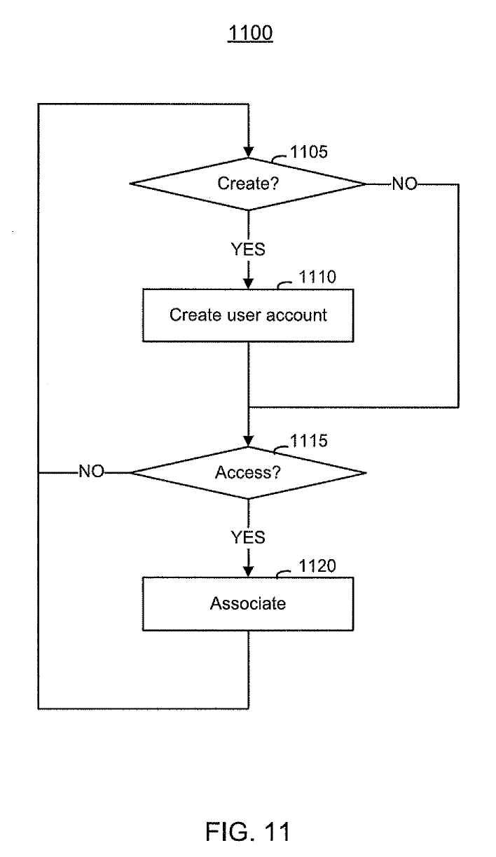

A user may access a service(s) of the search system 380 using various communication services, such as voice, mobile messaging such as SMS, EMS and MMS, instant messaging (IM), email, an internet connection, and/or other communication service(s). A user may desire to submit a search request and/or receive information from the search system 380 using any or all communication service(s) which are accessible to a user. In order to provide a user with information using one or more communication service(s), an identifier associated with a communication service may be associated with a unique identifier of a user. A process for associating one or more identifiers of a communication service(s) with a user identifier (ID) is described further herein below with respect to FIG. 11. If a first identifier of a communication service is associated with a second identifier of a communication service, information associated with a search request(s) submitted using the service associated with the first identifier may be provided using the communication service associated with the second identifier. For example, a user might submit a search request using a mobile phone and if a user login ID is associated with the mobile phone number which submitted the request, the user might access information regarding the search request and/or a search result(s), etc. via a web page or other internet communication associated with the user login.

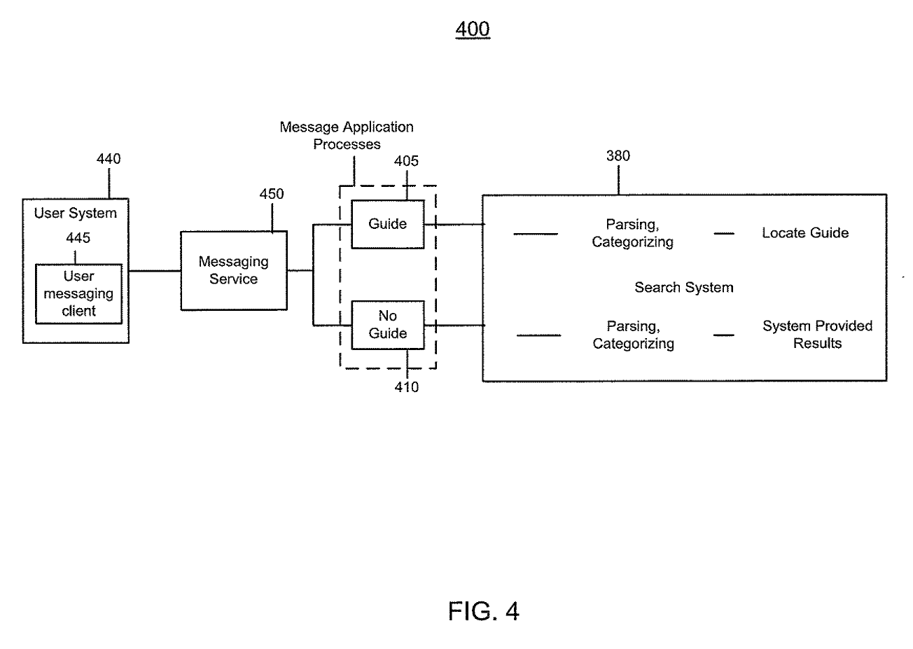

FIG. 4 depicts an alternate embodiment of a system 400 comprising a messaging interface to the search system 380. The system 400 may include at least one user system 440 and at least one messaging service 450. While a single user system is depicted for simplicity, any number of user systems may be communicatively coupled to the search system 380.

As illustrated in FIG. 4, more than one of each type of message application process can be provided. In at least one embodiment, two or more message application processes can be present in system 400. For example, in a system in which a search can be performed with a guide or without a guide a message application process can be provided for each search option. For example, a message application process 405 might be provided for a search with a guide and a message application process 410 might be provided for a search without a guide.

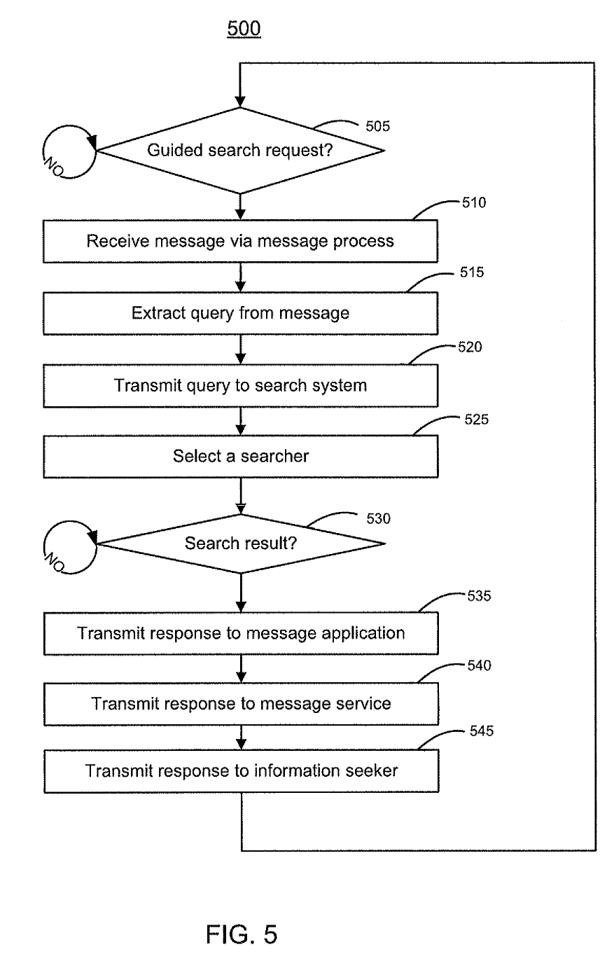

In such an instance, the message application process 405 for a search with a guide may allow a guide(s) and a user at a user system (e.g., a user system 440) to communicate using IM, email, SMS, EMS, MMS, voice, and/or other communication services. A process for conducting a guided search is further described herein below with respect to FIG. 5. Similarly, the message application process 410 for a search without a guide allows the search system 380 to operate as an IM buddy, email address, phone number or WAP with which a user at a user system such as the user computer 440 can communicate. It should be noted that the search system 380, the first message application, and the second message application are communicatively coupled to allow a human searcher (guide) and/or the search system 380 to provide a response to an information search query submitted by an information seeker via the messaging service 450. As illustrated in FIG. 4, when the ‘Guide’ message application process 405 for a search with a guide is selected, a search query may be parsed, categorized, and/or otherwise processed and a guide may be located to handle the search query. Likewise, when the ‘No Guide’ message application process 410 for a search without a guide is selected, a search query may be parsed and categorized, and a search result(s) provided by the search system 380 may be presented to a user without using the assistance of a guide. The ‘Guide’ message application process 405 and the ‘No Guide’ message application process 410 may appear to be associated with one or more of a URL(s), a phone number(s), an IM handle(s), a short code(s), an email address(es), etc. Communications between a guide(s) and a user(s) may be made anonymously as a user sees only the identifier associated with the ‘Guide’ message application process 405 and a guide(s) may not see any personally identifying information of a user. The use of multiple message application processes which are associated with different communication service identifiers may be used by the search system 380 to offer differentiated services. For example, a live interactive search might be a pay per use system, while an email or text based system might be advertising supported.

FIG. 5 illustrates an exemplary process 500 for a guided search.

In operation 505, a determination is made as to whether a search request which requires the assistance of a guide (or a searcher) is received. If in operation 505 it is determined that a search request is not received, control remains at operation 505 and process 500 continues. If in operation 505 it is determined that a search request is received, control is passed to operation 510 and process 500 continues.

In operation 510 a message is received including a user query, for example, via the instant message application 329, the voice messaging service 343, the mobile messaging application 319, or the email message application 339. For example, if the user 321 desired to obtain search results regarding the query, “Who won the World Series in 1988?” the query might be included in an instant message transmitted to the ‘ChaCha Live’ buddy 235 via the IM service 320 to message application process 405. Control is passed to operation 515 and process 500 continues.

In operation 515 a search query is extracted from a message. For example, the messaging process 405 may scan an incoming text string for a colon (“:”) and parse the text after the colon until a period, a question mark or other end of message indicator is encountered. A message(s) such as a voice message, an SMS, EMS or MMS message, an email, etc. may be processed to obtain information of a user query. Information such as an identifier of a user and/or a communication service associated with a query may be determined. Control is passed to operation 520 and process 500 continues.

In operation 520 a query message is transmitted to the search system 380, which may include any information determined using the message received in operation 510. In at least one embodiment, an identifier of a communication service associated with a search request is transmitted to the search system 380. Control is passed to operation 525 and process 500 continues.

In operation 525 a searcher(s) is selected. A searcher may be selected in various ways including by the search system 380. In at least one embodiment, a searcher is selected based at least in part on a ranking of a searcher(s) associated with a category(ies), a keyword(s) and a location(s) associated with a search request. However, the present invention is not limited to selecting a searcher based on any particular criteria. For example, a searcher to handle a request may be selected by another searcher who thinks that the selected searcher is better suited to handle the request. Control is passed to operation 530 and process 500 continues.

In operation 530 a determination is made as to whether search result is obtained. If in operation 530 it is determined that a search result is not obtained, control remains at operation 530 and process 500 continues. If in operation 530 it is determined that a search result is obtained, control is passed to operation 535 and process 500 continues.

In operation 535, a response (or a message) including a search result(s) is transmitted from the search system 380 to the message application process 405. Control is passed to operation 540 and process 500 continues.

In operation 540, a search result is processed by the message application 405 and a response message is transmitted to the message service 450. Control is passed to operation 545 and process 500 continues.

In operation 545 a response message is transmitted by the messaging service 450 to the messaging client 445. Control is passed to operation 505 and process 500 continues.

While the process 500 has been illustrated for a single message, any number of messages may be transmitted to the search system 380 from the user system 440, and any number of messages may be transmitted to the user system 440 by the search system 380. For example, a clarification message(s), an advertisement(s), and/or other information may be exchanged between a user, a guide(s) and/or the search system 380.

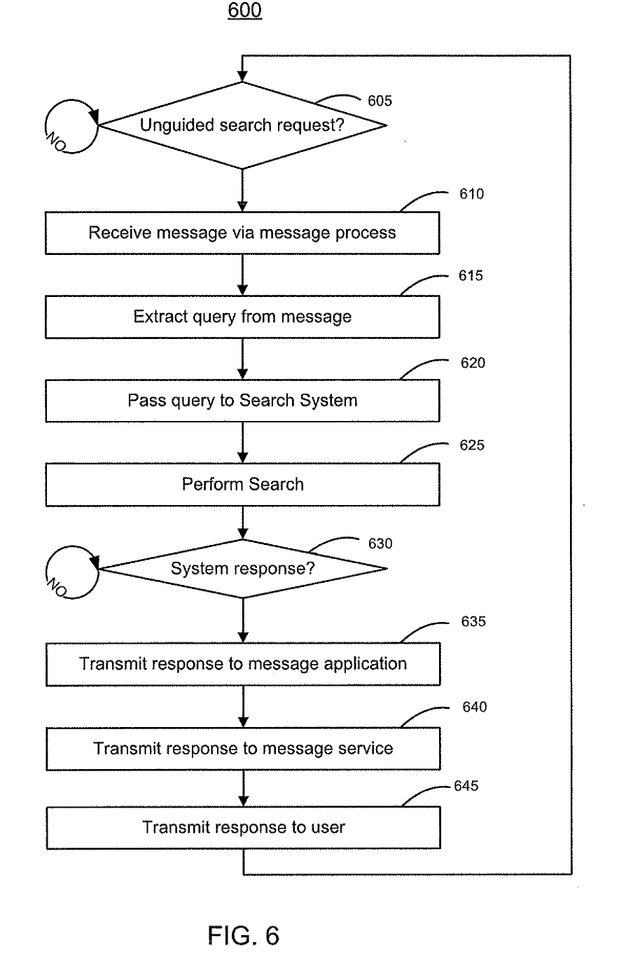

FIG. 6 illustrates an exemplary process 600 of an unguided search.

In operation 605, a determination is made as to whether a search request which does not request the assistance a guide is received. If in operation 605 it is determined that a search request is not received, control remains at operation 605 and process 600 continues. If in operation 605 it is determined that a search request is received, control is passed to operation 610 and process 600 continues.

In operation 610 a message is received including a user query, for example, via the instant message application 329, the voice messaging service 343, the mobile messaging application 319, or the email message application 339. For example, if the user 321 desired to obtain search results regarding the query, “Who won the World Series in 1988?” the query might be included in an instant message transmitted to the ‘ChaCha’ buddy 234 via the IM service 320 to message application process 410. Control is passed to operation 615 and process 600 continues.

In operation 615 a search query is extracted from a message. For example, the messaging process 410 may scan an incoming text string for a colon (“:”) and parse the text after the colon until a period, a question mark or other end of message indicator is encountered. A message(s) such as a voice message, an SMS, EMS or MMS message, an email, etc. may be processed to obtain information of a user query. Information such as an identifier of a user and/or a communication service associated with a query may be determined. Control is passed to operation 620 and process 600 continues.

In operation 620 a query message is transmitted to the search system 380, which may include any information determined using the message received in operation 610. In at least one embodiment, an identifier of a communication service associated with the search request is transmitted to the search system 380. Control is passed to operation 625 and process 600 continues.

In operation 625 a search is performed by the search system 380. The search at operation 625 is executed automatically and without requiring an input from a searcher (or a guide). A search result(s) may be obtained in various ways. In at least one embodiment, a search result may be selected based on one or more previously answered queries. In at least one embodiment, a processed search query may be submitted to a search resource(s) selected by the search system 380. Control is passed to operation 630 and process 600 continues.

In operation 630 a determination is made as to whether search result is obtained. If in operation 630 it is determined that a search result is not obtained, control remains at operation 630 and process 600 continues. If in operation 630 it is determined that a search result is obtained, control is passed to operation 635 and process 600 continues.

In operation 635 a response (or a message) including a search result(s) is transmitted from the search system 380 to the message application 410. Control is passed to operation 640 and process 600 continues.

In operation 640 a search result is processed by the message application 410 and a response message is transmitted to the message service 450. Control is passed to operation 645 and process 600 continues.

In operation 645 a response message is transmitted by the messaging service 450 to the messaging client 445. Control is passed to operation 605 and process 600 continues.

While the process 600 has been illustrated for a single message exchange, any number of messages may be transmitted to the search system 380 from the user system 440, and any number of messages may be transmitted to the user system 440 by the search system 380. For example, a clarification message(s), an advertisement(s), and/or other information may be exchanged between a user, a guide(s) and/or the search system 380.

It should be noted that although the embodiments described herein have been described in a one-on-one chat or instant messaging environment, the described embodiments may also be employed in other chat-room like scenarios. For example, the embodiments may be employed in an electronic chat room in which a first person is chatting with a second person, and the search system is invited into the chat room to provide search results to a search query. Similarly, the embodiments may be employed in an electronic chat room involving any number of human users.

Similarly, more than one communication session might occur between any user and the search system 380 using the messaging service/message application type interface. The search system might appear as a different ‘buddy’ alias, or phone/WAP access number or email address in the case where an information seeker selected, for example, to seek assistance from more than one guide(s) or group(s) of guides.

Communication with a user may occur via any number of communication device(s) and/or service(s). A user might for example submit a query or search request to the search system 380 (FIG. 3) via the instant message service 330 and the instant message application 329 and receive a response from the search system 380 via the mobile message application 319 and the mobile messaging service 310. Any type of a message such as a search request(s), a clarification, and/or other information from a user may be transmitted to the search system 380 using any messaging service(s) which are communicatively coupled to the search system 380. Any message from the search system 380 may be transmitted to a user such as the users 301, 311, 321, 331, 341 using any communication service(s) such as the mobile messaging service 310, the instant message service 320, the email service 330, the voice messaging service 343, and/or an internet service. Using this capability a user may submit a search request(s) and/or other information to the search system 380 using any communication service(s) and may receive a message(s) from the search system 380 using any communication service(s).

In an alternate embodiment, a message interface could be used to invoke guided versus unguided searching using a keyword in the text (e.g., ‘ChaGuide’) or some other indicator in the message content which would be recognized in operation 515 of the process 500. In such an embodiment, a single message application can perform the function of both the ‘Guide’ message application 405 and the ‘No Guide’ message application 410. It is thus possible for an information seeker to interact with the search system 380 using messaging technologies, including but not limited to voice, instant messaging, mobile messaging technologies such as SMS, MMS, and EMS, or email, as described above.

As part of the interaction between the IM service 320, the message application process 329 and the user IM client 323 and/or the mobile messaging service 310 and the mobile message application 319, it is possible to obtain information regarding the a user device which may include geographic data, such as area code or GPS information, and the capability of a user's device to receive and display advertising and/or other search results.

If it is determined during the interaction via the IM message application process 329 that the user IM client 323 could be upgraded to allow a better user experience interaction with the search system 380, the search system 380 may send a notification to a user via the IM service 320 to make the user aware of this opportunity.

If a user elects to upgrade the IM client 323, the search system 380 or the instant message application 329 may send a suitable URL by IM, email, link on the user portal home page, or other suitable communication service(s) to the user. The new IM client may for example be an enhanced version of the client from a user's IM service provider, or an IM client which allows a richer interaction between the user and the search system. For example, new types of media may be supported by an upgraded client, such as pictures, audio, video, or other media. The download and installation of a new messaging client can be accomplished using well-known technologies.

The database 385 (FIG. 3) includes data that is processed in association with operation(s) of the embodiments. Although FIG. 1 illustrates the database 385 as a separate component of the system, the database 385 may be integrated with the search system 380. Further, the records maintained in the database 385 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 385 may reside in any suitable elements of the system 300.

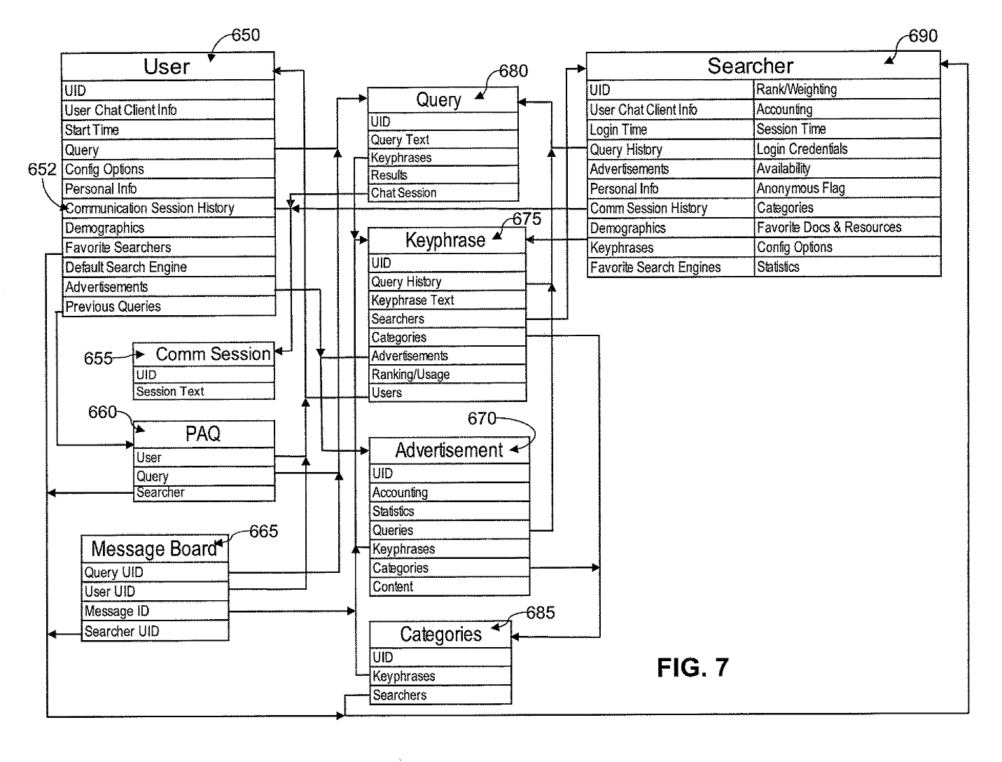

A database relationship between records which may be included in the database 385 is illustrated in FIG. 7. A user as indicated by the user record 650 has a unique identifier (UID). A user may be associated with any number of queries as indicated by the query record 680. Any query or request which has been previously searched and/or has a search result associated with the query may be indicated in a record such as the previously answered query (PAQ) record 660. A user record 650 may include a communication session history field 652 which may include a pointer to a record of a communication session(s) associated with the user as indicated in one or more records such as the communication session record 655. The communication session record 655 may include information of a communication service and content of a message(s) sent. The message board record 665 may indicate information of messages which are associated with a query. Information indicated in a message board record may be used to provide a message to a user(s) and/or a searcher(s). A query may be associated with various information. For example, a keyword(s) or keyphrase(s) and/or a category(ies) may be associated with a query based on an automated and/or human-assisted processing of a query. For example, the keyphrase record 675 and the category record 685 may include information of a searcher(s), an advertisement(s), a search resource(s), a search engine(s), and/or other item(s) which may be used to rank the item(s).

A ranking may be used to select an item(s). For example, an advertisement indicated by a record such as the advertisement record 670 may be provided to a user responsive to a query based at least in part on a ranking of the advertisement associated with a keyphrase(s) and/or category(ies) associated with the query. Similarly, a searcher indicated by a record such as the searcher record 690 may be selected to respond to a query based at least in part on a ranking of the searcher associated with a keyphrase(s) and/or category(ies) associated with the query.

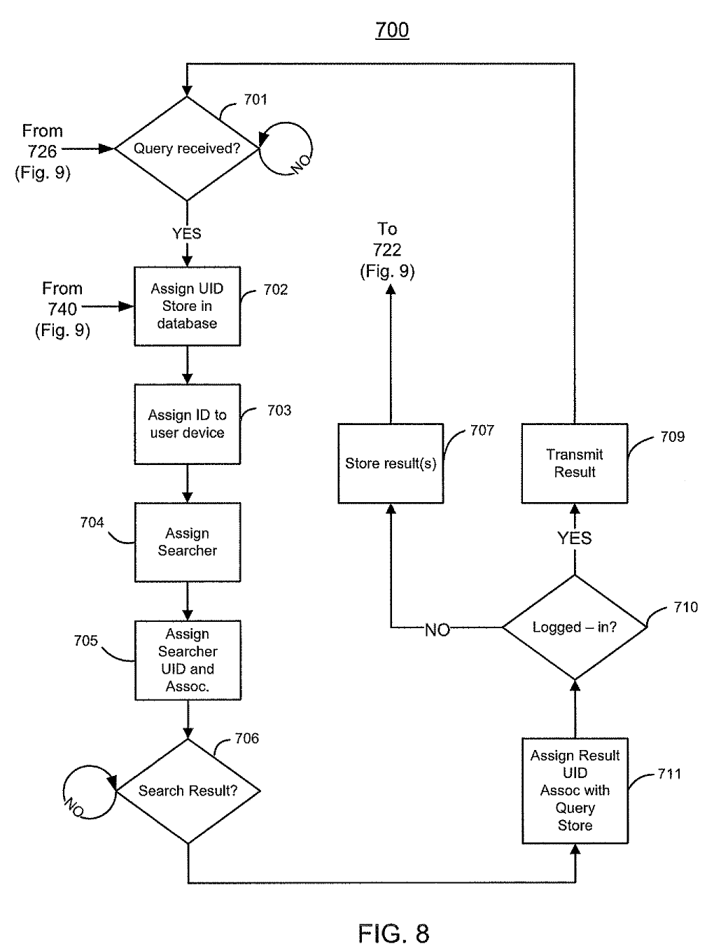

A process 700 of processing a search request is illustrated in FIG. 8.

In operation 701 a determination is made as to whether a query (or a search request) is received. If in operation 701 it is determined that a search request is not received, control remains at operation 701 and process 700 continues. If in operation 701 it is determined that a search request is received, control is passed to operation 702 and process 700 continues. As mentioned herein above, a query may be a fully-formed question, keyword(s) or a search phrase, and/or any other type of request for information.

In operation 702 a query is assigned a unique identifier (UID). The query and a unique identifier of the query are stored in the database 385 (FIG. 3). A unique identifier may be assigned to a query in various ways for example, a unique identifier may be generated randomly, may be based in part on an IP address, an email address, a telephone number, an IM credential, a user identifier, etc. Various forms of unique identifiers may be used within the scope of the disclosure herein. Control is passed to operation 703 and process 700 continues.

In operation 703 a unique identifier is associated with a source of a query. In at least one embodiment, a unique identifier may be based on a ‘cookie’ or other information associated with a user system, such as the user computer 302 (FIG. 3). In at least one embodiment, a unique identifier associated with a source of a query is one or more of a telephone number, an email address, an IM credential, a username, or communication service information which may be associated with a query received in operation 701. Control is passed to operation 704 and process 700 continues.

In operation 704 a searcher(s) is assigned to perform an information search responsive to a user query when a search with guide assistance is requested. Control is passed to operation 705 and process 700 continues.

In operation 705 a unique ID of the assigned searcher is associated with the unique ID of the query and the information is stored in the database 385. Control is passed to operation 706 and process 700 continues.

In operation 706 a determination is made as to whether a search result(s) is provided. If in operation 706 it is determined that a search result is provided, control is passed to operation 711 and process 700 continues. If in operation 706 it is determined that a search result is not provided, control remains at operation 706 and process 700 continues to wait.

In operation 711 a search result(s) is assigned a unique ID and associated with a query. Information of the association is stored in the database 385 (FIG. 3). A unique identifier of a search result may be assigned using any suitable process. Control is passed to operation 710 and process 700 continues.

In operation 710 a determination is made as to whether a user is logged-in. If in operation 710 it is determined that a user is logged in based on determination of a status of the user, control is passed to operation 709 and process 700 continues. If in operation 710 it is determined that user is a not logged in, control is passed to operation 707 and process 700 continues. The determination in operation 710 may be made based on various criteria. A user may be determined to be logged-in if a user is connected to the search system 380 using any communication service. For example, a user may submit a search request using a communication service such as the instant message service 320 (FIG. 3), but may be logged-in to the search system 380 by being able to send and/or receive a message via the mobile messaging service 310 (FIG. 3) if a telephone number associated with a user may be contacted.

In operation 709 a search result(s) may be sent to a user. A search result(s) may be sent to a user via any or all communication services associated with a user. If only an identifier associated with a query source is available, a search result may be transmitted to a destination identified by the unique ID of the source of the query. If more than one unique identifier of a communication service has been associated with a source of a query, a search result(s) may be provided using the information of the communication services associated with the source of the query. For example, a user may submit a search request using an SMS message and may elect to receive a search result(s) using a voice enabled device such as the user device 342 (FIG. 3), and to receive a search result(s) using web browser functionality at a secure URL using a device such as the user system 302. The selection of a communication service which may provide a search result(s) and/or other information to a user may be made according to various criteria as will be described further herein below. Control is passed to operation 701 and process 700 continues.

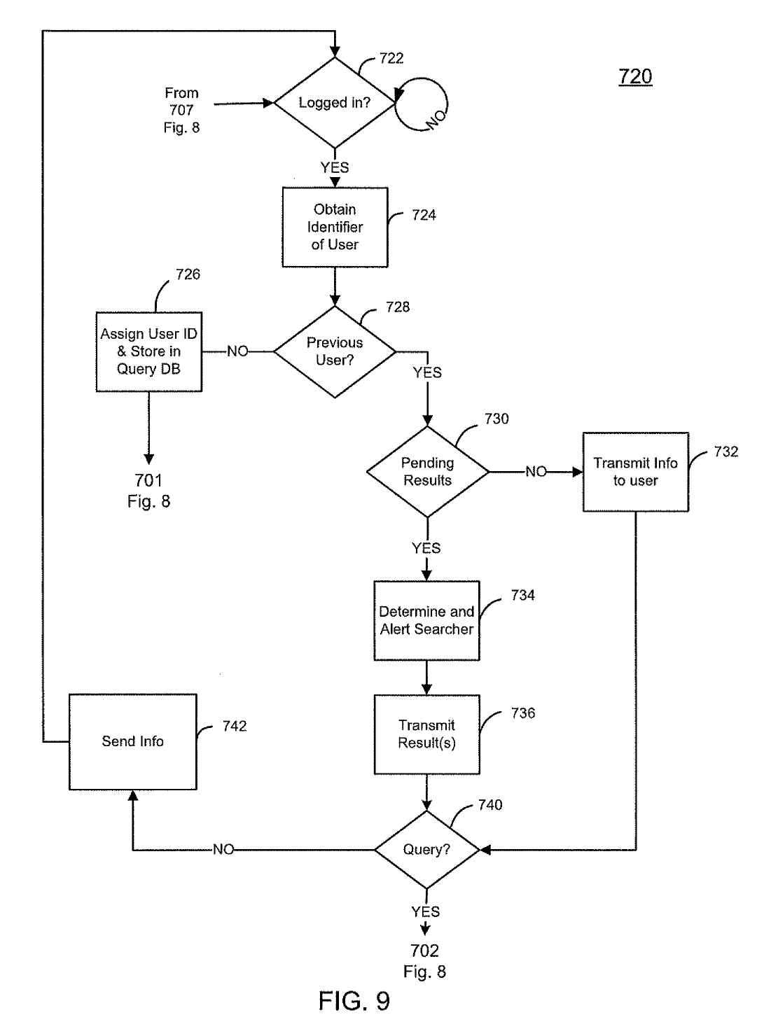

In operation 707 a search result(s) are stored in the database 385 (FIG. 3) in association with a unique identifier of a user device determined in operation 703 and a user query. Control is passed to operation 722 (FIG. 9) of process 720.

A process 720 for providing information to a user is illustrated in FIG. 9.

In operation 722 a determination is made as to whether a user is logged-in. If in operation 722 it is determined that a user is not logged-in, control remains at operation 722 and process 700 continues. If in operation 722 it is determined that a user is logged-in, control is passed to operation 724 and process 720 continues.

The determination in operation 722 may be made based on various criteria. For example, presence information assigned to a user(s) on the IM service 320 (FIG. 3) may be used to determine whether a user is logged in, a user may be determined to be logged-in if he is able to send and/or receive information using a communication service such as the instant messaging service 320 (FIG. 3), the email service 330, the mobile messaging service 310, the voice service 343, an internet connection, and/or other communication service(s).

In operation 724 an identifier of a user is obtained. For example, an IP address assigned to a computer, a persistent ‘cookie’, a phone number(s), email address, IM credential, a user ID and/or any identifier of a communication service and/or device may be utilized as an identifier of a user. A process for associating one or more identifiers of a communication service(s) with a user identifier is described further herein below. Control is passed to operation 728 and process 720 continues.

In operation 728 a determination is made as to whether a user is a previous user. The determination in operation 728 may be made based upon any information indicated in the system database 385 (FIG. 3). If an identifier of a user is indicated in the database 385, it may be determined that the user is a previous user. More than one identifier of a user may be associated with a user. For example, a user may be associated with a user login ID which has been obtained using a web page of the search system 380, a telephone number(s), or other identifier of a user device(s), an IM credential(s), an email address, or any other information which may be used to identify a user. If in operation 728 it is determined that a user is not a previous user control is passed to operation 726 and process 720 continues. If in operation 728 t is determined that a user is a previous user, control is passed to operation 730 and process 720 continues.

In operation 726 a unique ID is assigned to the identifier obtained in operation 724 and the unique ID is stored in the database 385 (FIG. 3). A unique ID may be assigned based on any information associated with a service and/or a device(s) which has established a communication session with the search system 380 in operation 722. The unique ID may be utilized to associate more than one identifier of a communication device(s) and/or service(s) with a user. Control is passed to operation 701 (FIG. 8) of process 700.

In operation 730 a determination is made as to whether a search result(s) and/or other information is available to be transmitted to a user. If in operation 730 it is determined that a search result or other information is not available to be transmitted to a user, control is passed to operation 732 and process 720 continues. If in operation 730 it is determined a search result(s) and/or other information is available to be transmitted to a user, control is passed to operation 734 and process 720 continues. The determination in operation 730 may be made based on various criteria. For example, a search result(s) or other information such as an advertisement(s) may be determined to be available based on information of a user device, or a communication service(s) which a user has employed to communicate with the search system 380 (FIG. 3), or based on whether a search result(s) have been previously transmitted to a user, or whether a user has requested that a search result(s) or other information be transmitted using a communication service(s).

In operation 732 a survey and/or other information may be transmitted to a user. For example, if a user has not logged-in to the search system 380 (FIG. 3) during a time interval, if a user has not submitted a search request during a time interval, or if a user has previously received information, information such as a survey, an advertisement(s), etc. may be transmitted to a user. Control is passed to operation 740 and process 720 continues.

In operation 734 a searcher(s) may be identified and a notification may be transmitted to a searcher. For example, a searcher who has previously handled a query for a user may be identified and may be sent an email, an instant message, and/or any other form of notification. Such a notification may inform a searcher that a search result(s) will be provided to a user(s). A query associated with a unique identifier of a user may be used to obtain information of a query submitted by the user. A search result(s) associated with a query is associated with a searcher(s). If a search result(s) associated with a searcher is provided to a user responsive to a query submitted by the user, the searcher may be notified. Control is passed to operation 736 and process 720 continues.

In operation 736 a search result(s) and/or other information is transmitted to a user. For example, a search result(s), a clarification request, an advertisement(s), etc. may be transmitted to a user. Any or all information available to be provided to a user may be transmitted in operation 736. Control is passed to operation 740 and process 720 continues.

In operation 740 a determination is made as to whether a query has been received. If in operation 740 it is determined that a query has been received control is passed to operation 702 (FIG. 8) of process 700. If in operation 740 it is determined that a query has not been received, control is passed to operation 742 and process 720 continues.

In operation 742 a user may be provided the opportunity to communicate with a searcher(s), to review search result(s) which may have been provided responsive to a user request(s), to participate in an activity such as a survey, etc. Any type of information may be transmitted to a user in operation 742. Control is passed to operation 722 and process 720 continues.

Because a user has a unique ID, which is associated with a unique ID of each query submitted by a user, and a searcher has a unique ID which is associated with a unique ID of a query(ies) which were answered by the searcher, and a search result(s) has a unique ID which is associated with a searcher ID and a query ID it is possible to establish and re-establish anonymous communication between a searcher and a user. No identifying information (email, IM credentials, phone number, etc.) of a user(s) and/or a searcher(s) would need to be revealed in order for communication to occur using any communication service(s) coupled to the search system 380 (FIG. 3).

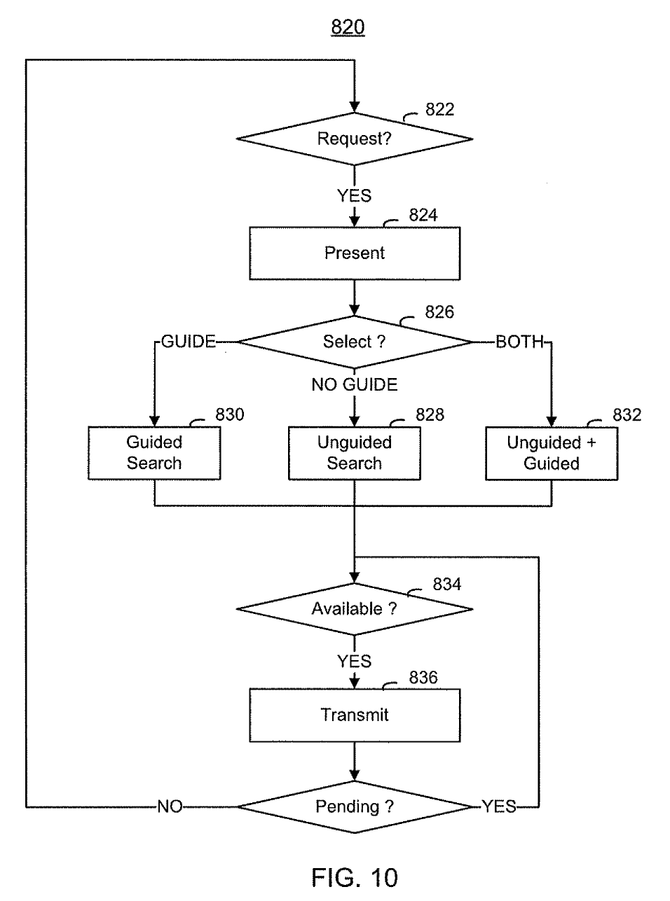

A process 820 for performing a search is illustrated in FIG. 10.

In operation 822 a determination is made as to whether a search request has been received. If in operation 822 it is determined that a search request has not been received, control remains at operation 822 and process 820 continues to wait. If in operation 822 it is determined that a search request has been received, control is passed to operation 824 and process 820 continues.

In operation 824 a user is presented with an option to perform a search utilizing a human searcher, a search without utilizing a human searcher or both. A user may be provided with such an option in various ways. For example, a user may send a message to an email address(es), an IM buddy(ies), a short code(s), or a telephone number(s) which may indicate selection of any option(s). Alternately, a user may select an option(s) using a GUI, a voice menu, or other interface. Control is passed to operation 826 and process 820 continues.

In operation 826 a determination is made as to whether a user selects a search with a guide, a search without a guide, or both a search with a guide and a search without a guide. If in operation 826 it is determined that a user selects a search with a guide, control is passed to operation 830 and process 820 continues. If in operation 826 it is determined that a user selects a search without a guide, control is passed to operation 828 and process 820 continues. If in operation 826 it is determined that a user selects a search without a guide and a search with a guide, control is passed to operation 832 and process 820 continues.

The determination in operation 826 may be made based on various criteria. In at least one embodiment, the system 380 (FIG. 3) may determine the option selected based upon a communication service, or other information associated with a user. For example, a user who submits a search request using a voice based device may always receive assistance from a guide, or a user submitting a query using an email service may receive an automated reply followed by a reply from a human guide if the search system was unable to provide a search result(s) from the information provided in the search request, etc.

In operation 830 a search is performed using the assistance of a human guide. A guide may interact with a user, and may produce a search result(s) responsive to a user request. Control is passed to operation 834 and process 820 continues.

In operation 828 a search is performed without the assistance of a human guide. The search system 380 may interact with a user and may provide a search result(s) responsive to a user request or query. Control is passed to operation 834 and process 820 continues.

In operation 832 a search is performed without the assistance of a human searcher or guide. A search result(s) from an unguided search may be provided responsive to a user request. A search utilizing the assistance of a human searcher or guide is performed. A searcher may be notified that an unguided search responsive to a user query is performed. A searcher may interact with a user and may provide a search result(s) responsive to a user request. A search result(s) provided by an automated search may be provided to a guide or human searcher. Control is passed to operation 834 and process 820 continues.

In operation 834 a determination is made as to whether a search result(s) is available to transmit to a user. If in operation 834 it is determined that a search result(s) is available to transmit to a user, control is passed to operation 836 and process 820 continues. If in operation 834 it is determined that a search result(s) is not available to transmit to a user, control remains with operation 834 and process 820 continues.

In operation 836 a search result(s) is transmitted to a user. Control is passed to operation 838 and process 820 continues. A search result(s) may be transmitted to a user via any communication service(s) associated with a user.

In operation 838 a determination is made as to whether a search result(s) is pending. If in operation 838 it is determined that a search result(s) is not pending, control is passed to operation 822 and process 820 continues. If in operation 838 it is determined that a search result(s) is pending, control is passed to operation 834 and process 820 continues.

The determination in operation 838 may be made based on various criteria. For example, a search result(s) may be pending based upon an indication by a searcher that additional search result(s) may be produced responsive to a user search request, based upon a number of search result(s) which have been transmitted to a user, based upon user acceptance of a number of search result(s), based upon whether a result has been transmitted using a communication service(s) associated with a user, etc.

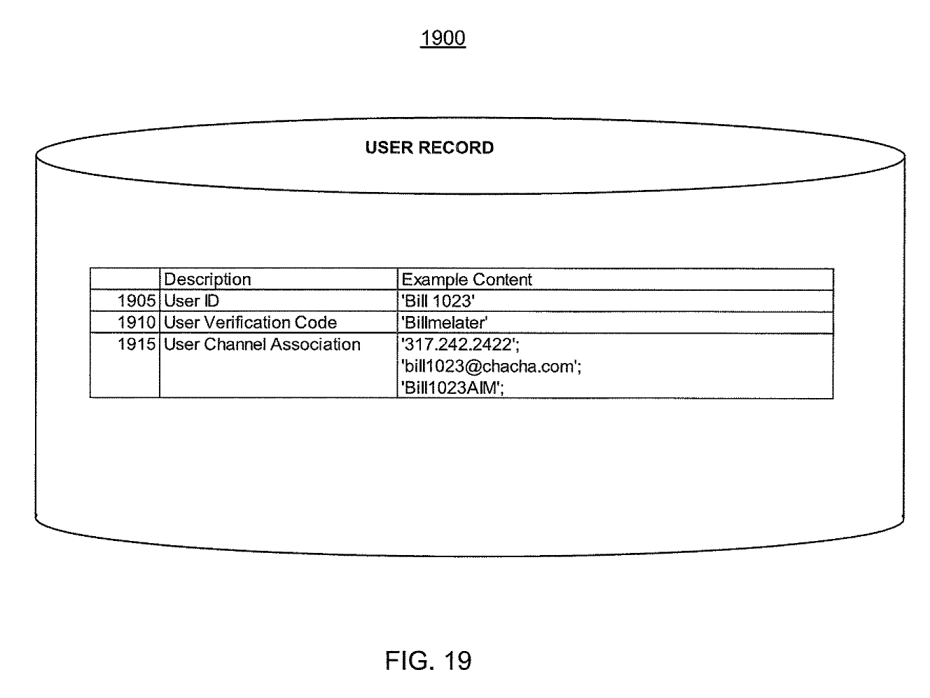

As illustrated herein above, an identifier of a user such as a telephone number, IM credentials, email address, or other identifier may be associated with a unique identifier of a user. In at least one embodiment, a user may elect to create a user login account. A user record such as the record 1900 illustrated in FIG. 19 may include any information associated with a user by the search system 380 (FIG. 3).

As illustrated in FIG. 11 a process 1100 for associating one or more communication services with a user is provided.

In operation 1105 a determination is made as to whether a user requests to create a user account. If in operation 1105 it is determined that a user does not request to create an account, control is passed to operation 1115 and process 1100 continues to wait. If in operation 1105 it is determined that a user requests to create an account, control is passed to operation 1110 and process 1100 continues.

The determination in operation 1105 may be made based on various criteria. In at least one embodiment, a user may create an account by providing a user login ID and password using a web page provided by the search system 380 (FIG. 3). Alternately, an email sent to a particular email address might be used to create a user account associated with the source email address.

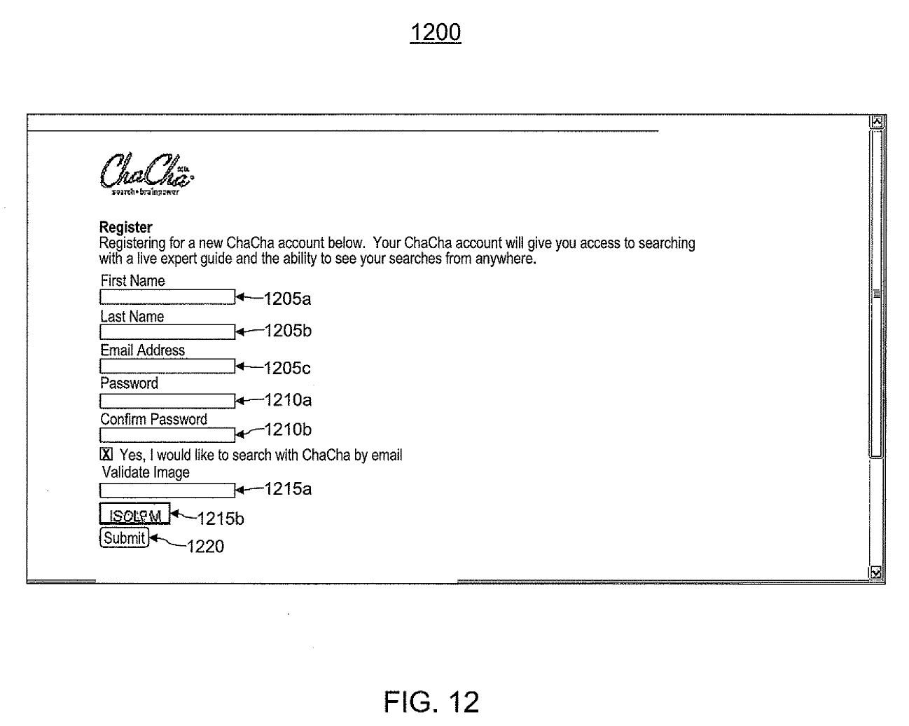

In operation 1110, a user account is created. A user may be presented with a GUI such as the GUI 1200 illustrated in FIG. 12. A user login ID is created and a user password is assigned. In at least one embodiment, a confirmation email may be sent to an email address provided by a user in order to verify the identity of the user. A temporary password may be provided, which may be modified by a user. A user account may be created using any type of identification information and any communication service. For example a user may create an account using voice, text, IM, email, etc. Control is passed to operation 1115 and process 1100 continues.

In operation 1115 a determination is made as to whether a request to access a user account is received. If in operation 1115 it is determined that an access request is not received, control remains with operation 1115 and process 1100 continues. If in operation 1115 it is determined that a request to access a user account is received, control is passed to operation 1120 and process 1100 continues.

The determination in operation 1115 may be made based on verification of a user login ID and confirmation of security information such as a user password, and/or other security information associated with a user login ID. A request to access a user account may be received using any communication services which may communicate with the search system 380.

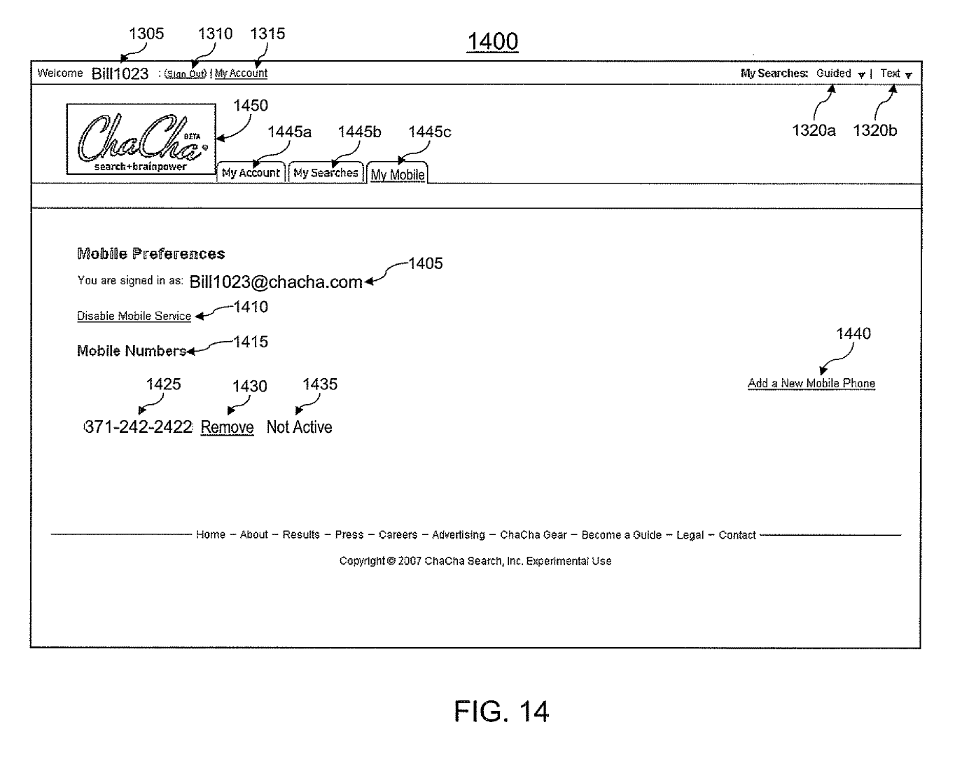

In operation 1120 a user is provided with an option to associate communication information of a user with a user ID. For example, a user may be presented with a GUI such as the GUI 1400 illustrated in FIG. 14. A user may elect to associate various types of identifying information with a user ID. For example, a user may associate a telephone number, an IM credential, an email address, or any other identifier with a user ID. Control is passed to operation 1105 and process 1100 continues.

Using the association established using the process 1100, if a user communicates with the search system 100 (FIG. 1) using any service(s) which is associated with a user ID, access may be granted to a previous search query(ies), search result(s), searcher(s), and/or any other information which may have been provided by a search system such as the search system 380 which were submitted using any communication service(s) and/or device(s) which is associated with a user ID.

As disclosed herein above with respect to FIG. 8 and FIG. 9, a unique identifier may be assigned to a user which is related to any identifier of the user, such as a persistent ‘cookie’, an IP address, a phone number, an IM credential, a login ID and/or any other identifier(s) of a device(s) or service(s). If a user connects to the search system 380 using any service(s) associated with a user ID, the search system 380 may provide various information such as a search query history, a search result(s) history, advertisement(s), searcher(s) list, search classification(s), search resource(s), affiliate groups associated with a search request(s), and any other information which may have been provided responsive to a query(ies) submitted, using any communication service(s) and/or device(s) associated with a user ID to a user.

For example, a user may submit a voice query to the search system 380 from a user system and might receive an SMS message from the search system 380 with a search result(s) and/or an advertisement(s) at the user system. If a user has associated a phone number associated with a user system with a login ID, the user may access the search system 380 using a browser functionality of any user system which may allow the user to access information of a search request(s) associated with the phone number.

An example user registration GUI 1200 is illustrated in FIG. 12. The GUI 1200 may include user information indicators 1205, password indicators 1210, CAPTCHA controls 1215, and an action button 1220.

The user information indicators 1205 may be used to indicate information of a user. The first name user information indicator 1205a may be used to provide first name information. The last name user information indicator 1205b may be used to provide last name information. The email address user information indicator 1205c may be used to provide email address information. The password indicators 1210 may be used to provide and confirm a password. The ‘password’ password indicator 1210a may be used to provide a desired password. The ‘confirm password’ password indicator 1210b may be used to confirm a desired password. The CAPTCHA 1215 may be used to verify a visual indicator. The CAPTCHA entry box 1215a may be used to provide an interpretation of the information provided in the CAPTCHA display box 1215b. The action button 1220 may be used to submit the information provided in the GUI 1200 to the search system 380. An email address provided may be used for security and confirmation purposes.

While the login GUI 1200 has been described with respect to the example illustrated in FIG. 12, other types of registration interfaces, such as voice-controlled menu (voice xML), an interactive menu, etc. may be utilized to accomplish the user registration. Other information may be obtained in order to establish a user login ID.

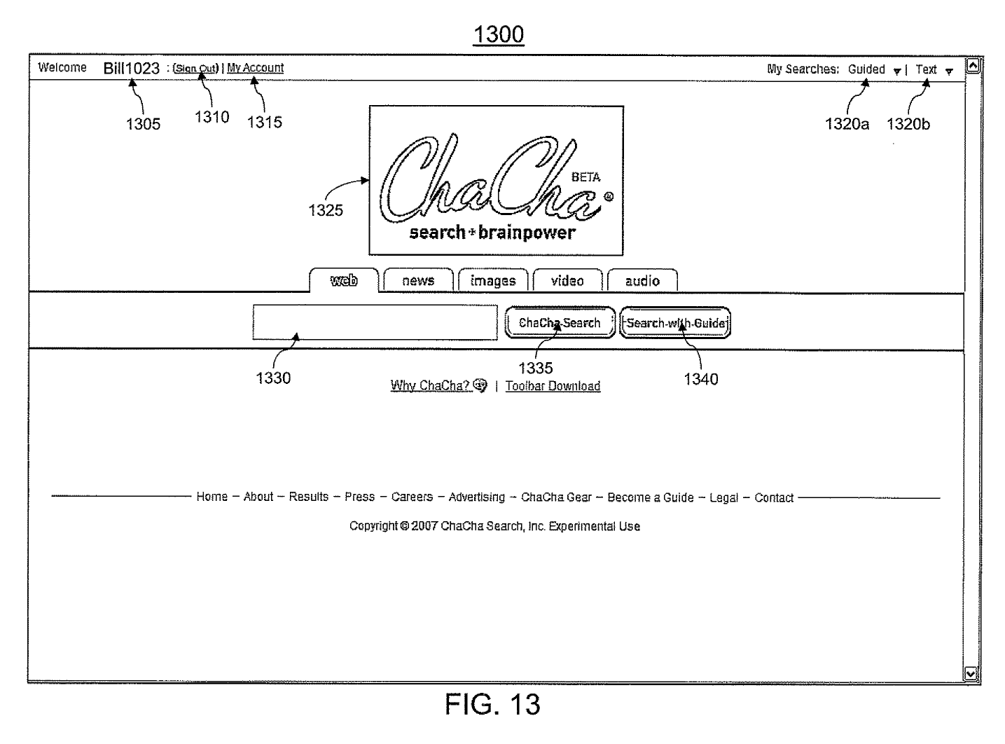

An exemplary GUI for a user to conduct a search as a logged-in user is illustrated in FIG. 13. The GUI 1300 includes a user identifier 1305, a sign-in control 1310, an account viewing control 1315, search review controls 1320, an advertising window 1325, a query box 1330, an unguided search button 1335, and a guided search button 1340. The GUI 1300 may be presented as a landing page when a user logs in to the search system 380 (FIG. 3).

The user identifier 1305 indicates information associated with a user login account. The user identifier may be based on any information submitted during a registration process. The sign-in control 1310 may be used to log in and log out of the search system 385.

The account viewing control 1315 may be used to view and modify information associated with a user account. Activation of the account viewing control 1315 may cause the GUI 1400 illustrated in FIG. 14 to be provided.

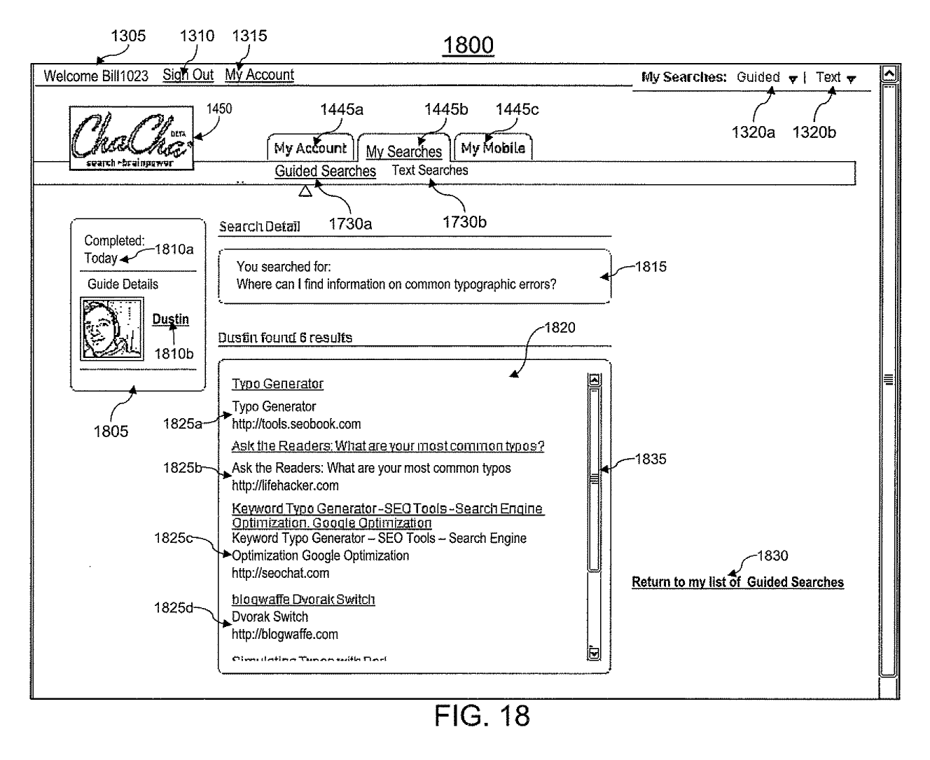

The search review controls 1320 may be used to review historical search information. Activation of the search review controls 1320 may cause a list of previous search queries to be presented to a user as for example a drop-down list. If a user selects an item from a list provided using a search review control, a GUI such as the GUI 1800 illustrated in FIG. 18 may be provided. Activation of the ‘Guided’ search review control 1 320a may cause a drop-down list of search queries utilizing a guide associated with a user login to be provided. Activation of the ‘Text’ search review control 1320b may cause a drop-down list of search queries submitted using a text-based device(s) associated with a user ID to be provided.

The advertising window 1325 may present an advertisement of any type. More than one advertising window 1325 may be present within the GUI 1300. An advertisement may be targeted to a user based on information associated with a user ID and/or other information indicated in the GUI 1300. Further, an advertisement may be presented based on a communication service being used to deliver information to a user. For example, content provided using an SMS service may be different than an advertisement provided via an email service.

The search query box 1330 may be used to enter a search query. The ‘ChaCha Search’ unguided search button 1335 may be used to request an unguided search. The ‘Search with a Guide’ search button 1340 may be used to request a search utilizing the assistance of a human searcher.

An exemplary GUI 1400 for a user to associate a device and/or other communication service(s) with a user ID is illustrated in FIG. 14. The GUI 1400 includes a user identifier 1405, a service election control 1410, a channel type identifier 1415, a channel identifier 1425, a channel deactivation control 1430, a channel status indicator 1435, a channel addition control 1440, account selection tabs 1445 and an advertising window 1450. The GUI 1400 may be presented to a user at any time responsive to a request to associate a new device or other communication channel with a user ID.

The user identifier 1405 indicates information associated with a user account. The user identifier may be based on any information provided to the search system during a registration process. Using the example illustrated in FIG. 14, a user identifier is the email address of a user associated with the login account.

The service election control 1410 may be used to select to enable or disable a type of service. Activation of the service election control 1410 may enable or disable a type of service associated with a user. For example, a user may elect to deactivate all access using mobile messaging, or IM, or voice, etc.

The channel identifier 1415 indicates the type of communication channel which is associated with a user account. More than one channel identifier 1415 may be present in the GUI 1400. Using the example illustrated in FIG. 14, the channel identifier indicates that a mobile phone number(s) may be associated with a user ID.

The channel identifier 1425 indicates information of one or more communication channels associated with a user ID. Such information may include a phone number, an email address, an IM login ID and provider etc. The channel deactivation control 1430 may be used to remove a selected communication channel from the list of communications channels associated with a user ID. A user may elect to remove a communication channel due to various reasons such as change of phone number(s), modification of a service provider(s), and/or cancellation of an account(s). The channel status indicator 1435 indicates whether a communication channel is actively available to a user for submitting and/or reviewing information associated with a search query(ies). While a phone number is used for purposes of illustration in FIG. 14, no limitation is implied thereby.

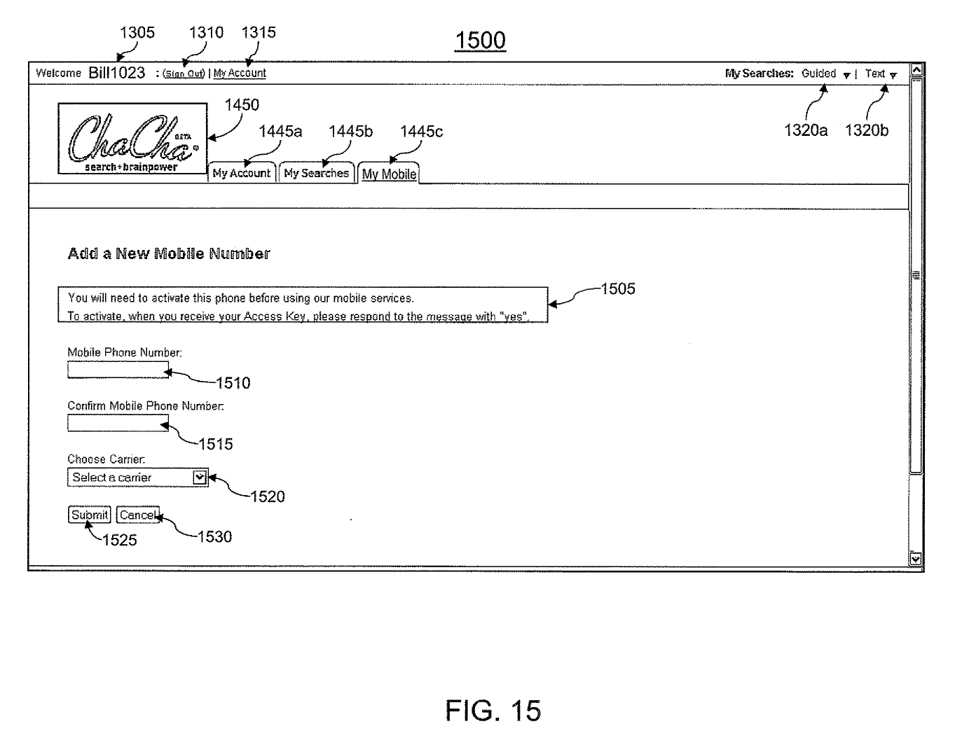

The channel addition control 1440 may be used to indicate that a new communication service is to be added to the list of services associated with a user ID. If the channel addition control 1440 is activated, the GUI 1500 illustrated in FIG. 15 may be provided.

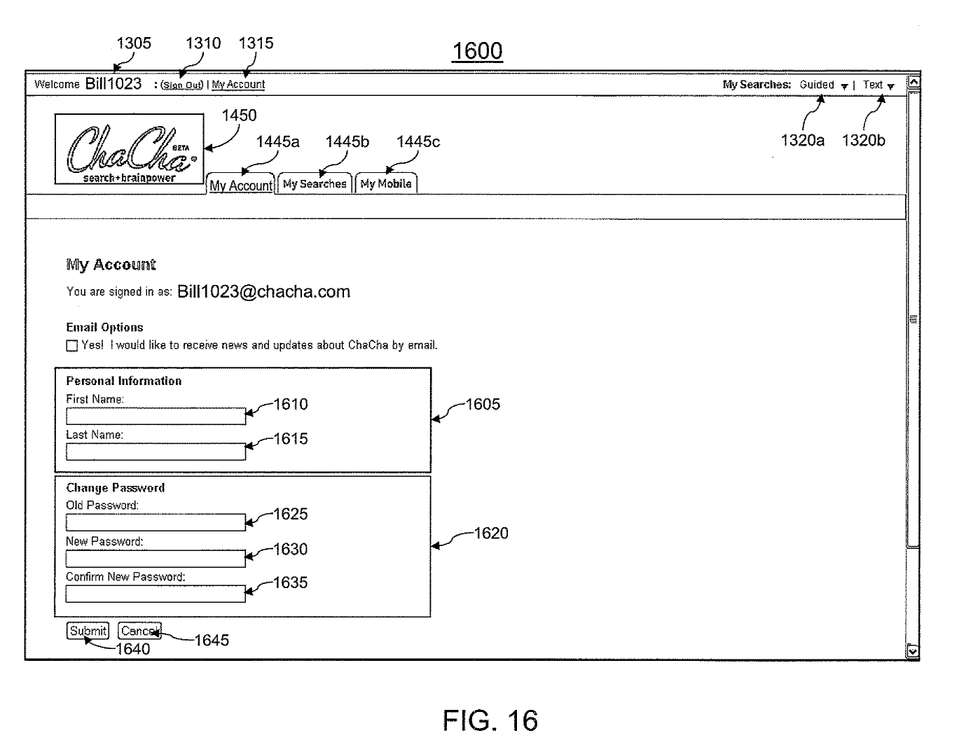

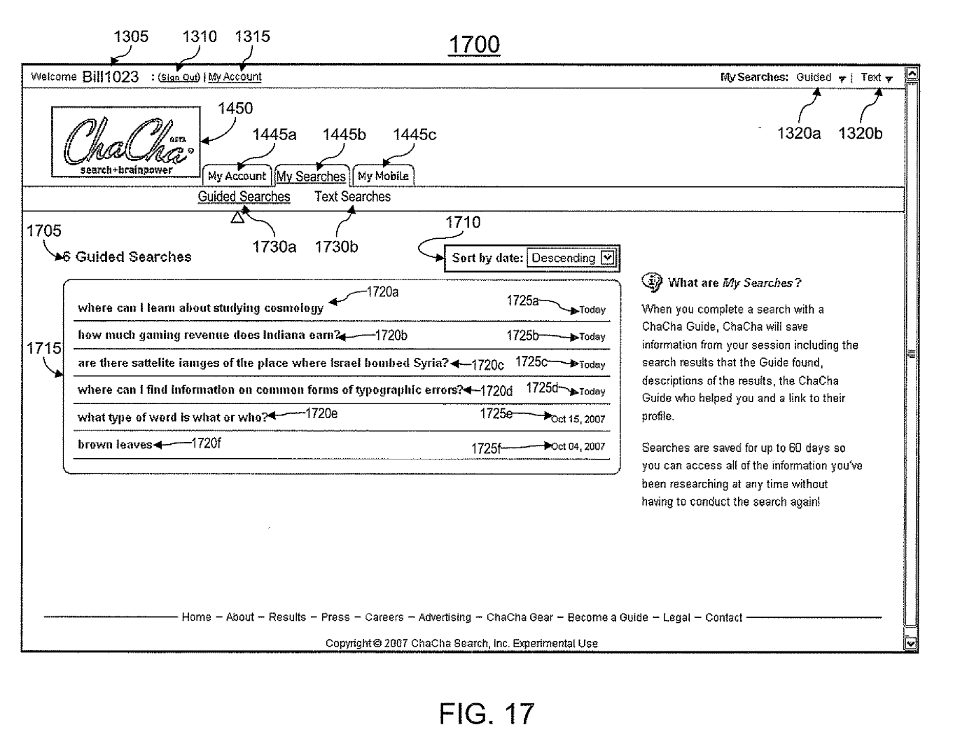

The account selection tabs 1445 allow a user to view information associated with a user account. Using the example illustrated in FIG. 14, activation of the ‘My Account’ account selection tab 1445a may cause the GUI 1600 illustrated in FIG. 16 to be provided. Activation of the ‘My Searches’ account selection tab 1445b may cause the GUI 1700 illustrated in FIG. 17 to be provided. Activation of the ‘My Mobile’ account selection tab 1445c may cause the GUI 1400 illustrated in FIG. 14 to be provided.

The advertising window 1450 may present an advertisement of any type. More than one advertising window 1450 may be present within the GUI 1400. An advertisement may be targeted to a user based on information indicated in the database 385 (FIG. 3).

While association of a communication channel with a user ID has been described with respect to the GUI 1400 illustrated in FIG. 14, other types of interfaces may be utilized to associate a device(s) and/or communication channel(s) with a user ID. For example, a user might associate a device with a user ID by sending a text message from the device, receiving a confirmation message and replying to the confirmation message or a user might call a telephone number, request to associate the originating number with a user ID, and provide verification information via voice, text, or other communication service(s).

An exemplary GUI 1500 for a user to associate a device or other communication service(s) with a user ID is illustrated in FIG. 15. The GUI 1500 includes user instructions 1505, a phone number entry box 1510, a phone number confirmation box 1515, a carrier selection box 1520, a submit button 1525, and a cancel button 1530. The GUI 1500 may be presented to a user at any time responsive to a request to associate a new device or other communication service with a user ID.

The user instructions 1505 explain how a user may associate a new communication channel with a user ID. Instructions may be provided for completion of an association process using any type of communication service(s) and/or device(s). Using the example illustrated in FIG. 15, a user is provided with instructions to confirm addition of a mobile phone for text service.

The phone number entry box 1510 may be used to provide information associated with a mobile phone number. The phone number confirmation box 1515 may be used to confirm information provided in the phone number entry box 1515. Preferably a 10-digit phone number may be provided. The carrier selection box 1520 may be used to designate a telephone service provider associated with a phone number. The carrier selection box 1515 is preferably implemented as a drop-down list of carriers that may support the search services of the search system 380. Telephone subscription information may be used for customer service and/or billing purposes.

The submit button 1525 may be used to submit the information indicated in the GUI 1500 for processing. The cancel button 1530 may be used to discard information indicated in the GUI 1500 and return to the GUI 1400.

While association of a communication channel with a user ID has been described with respect to the GUI 1500 illustrated in FIG. 15, other types of interfaces may be utilized to associate a device(s) and/or communication channel(s) with a user ID. For example, a user might associate a device by sending a text message from that device, receiving a confirmation message and replying to the confirmation message or a user might call a telephone number, request to associate the originating number with a user ID, and provide verification information via voice, text, or other communication service(s).

An exemplary GUI 1600 for a user to manage information associated with a user ID is illustrated in FIG. 16. The GUI 1600 includes personal information entry controls 1605, password controls 1620, a submit button 1640, and a cancel button 1645. The GUI 1600 may be presented to a user at any time responsive to a request to manage information associated with a user ID.

The personal information entry controls 1605 may be used to enter or change personal information associated with a user login ID. The personal information entry controls 1605 may include the first name box 1610 which may be used to provide first name information and the last name box 1615 which may be used to provide last name information.

The password controls 1620 may be used to modify a user password associated with a user ID. The password controls 1620 may include an old password entry box 1625, a new password entry box 1630, and a new password confirmation box 1635. The old password entry box 1625 may be used to provide a current password associated with a user ID. The new password entry box 1630 may be used to provide a new password to be associated with a user ID. The new password confirmation box 1635 may be used to confirm a new password associated with a user ID.

The submit button 1640 may be used to submit the information indicated in the GUI 1600 for processing. The cancel button 1645 may be used to discard any information indicated in the GUI 1600 and return to the GUI 1300.

While a specific set of user information is described in FIG. 16, other information of a user may be obtained by the search system.

An exemplary GUI 1700 for a user to review historical search information is illustrated in FIG. 17. The GUI 1700 includes a search type indicator 1705, search sorting controls 1710, a search history list 1715, search query indicators 1720, search timestamp indicators 1725, and search type selection tabs 1730. The GUI 1700 may be presented to a user at any time responsive to a request to review a search history associated with a user ID.

The search type indicator 1705 indicates the type of search which was conducted, and an indication of the number of historical search sessions available to a user. The search sorting controls 1710 allow a user to sort historical searches based on selectable criteria. The sorting controls 1710 are preferably implemented as a drop-down list of options, which may include date, topics, and/or other sorting criteria.

The search history list 1715 indicates information of a search query(ies). The search history list 1715 includes the search query indicators 1720, and the search timestamp indicators 1725. The search query indicators 1720 display information of a query, which may include text, audio, images, etc. A hyperlink may be associated with a search query indicator 1720. The search timestamp indicators 1725 indicates time information associated with a search request. The search query indicator 1720a indicates a search request regarding cosmology which was conducted ‘Today’ as indicated by the search timestamp indicator 1725a. The search query indicator 1720b indicates a search request regarding ‘gaming’ which was conducted ‘Today’ as indicated by the search timestamp indicator 1725b. The search query indicator 1720c indicates a search request regarding a news item which was conducted ‘Today’ as indicated by the search timestamp indicator 1725c. The search query indicator 1720d indicates a search request regarding typographic errors which was conducted ‘Today’ as indicated by the search timestamp indicator 1725c. The search query indicator 1720e indicates a search request regarding grammar which was conducted ‘today’ as indicated by the search timestamp indicator 1725e. The search query indicator 1720f indicates a search request regarding ‘brown leaves’ which was conducted ‘today’ as indicated by the search timestamp indicator 1725f. Activation of the search query indicator 1720d may cause a GUI such as the GUI 1800 illustrated in FIG. 18 to be provided.

The search type selection tabs 1730 may to select queries which have been submitted using various communications channels. Activation of the ‘Guided Searches’ search type selection tab 1730a may cause the GUI 1700 to be displayed. Activation of the ‘Text Searches’ search type selection tab 1730b may provide a GUI which allows a user to review search requests submitted using a text device. Additional search type selection tabs 1730 may be provided based on the communication channels associated with a user ID.

An exemplary GUI 1800 for a user to review historical search results is illustrated in FIG. 18. The GUI 1800 includes a guide information window 1805, guide information indicators 1810, a query indicator 1815, a search review window 1820, search result indicators 1825, and a return control 1830. The GUI 1800 may be presented to a user at any time responsive to a request to review a search session.

The guide information window 1805 indicates information of a guide(s) who conducted a search. The completion indicator 1810a may be used to indicate when a search was completed. The guide information indicator 1810b may provide a hyperlink to a web page associated with a guide. Any information of a guide(s) may be provided in the guide indicator window 1805.

The query indicator 1815 indicates information of a search query. The query indicator 1815 may include text, images, audio, etc. which is associated with a query.

The search review window 1820 may be used to review search results which have been provided. The search review window 1820 may include the search result indicators 1825. The search result indicators 1825 may include a hyperlink to a web resource identified by a guide, and a text snippet and/or other description associated with a search result by a guide. Any information associated with a search result may be indicated in a search result indicator 1825. The search result indicator 1825a indicates the result ‘Typo Generator’. Activation of the ‘Typo Generator’ hyperlink associated with the search result indicator 1825a may direct a browser to the website <<http://tools.seobook.com>>. The search result indicators 1825b, 1825c, and 1825d indicate other search results associated with the query ‘Where can I find information on common typographic errors?’ The return control 1830 allows a user to return to the GUI 1700 depicted in FIG. 17. The navigation controls 1835 may be used to navigate within the content of the search review window 1820.

The GUIs described herein allow a user to review any information associated with a search request which has been submitted by a device(s) associated with a communication service(s) which has been associated with a user ID using a browser functionality of a user system. Such capability may for example allow a user to obtain a search result via a first device and/or communication service, and later review additional information associated with the search request using a different device and/or communication service. Likewise, a user may elect to submit a search request using a first device and/or communication service and may receive a search result(s) using a different device and/or communication service.

As illustrated in FIG. 19, a sample of a user record 1900, of which one or more may be associated with or resident in the search database 385 (FIG. 3), may include a user identifier (ID) field 1905, a user verification code field 1910, and a user communication information field 1915.

The user ID field 1905 contains a unique identifier of the user, which is preferably used consistently. For example, in at least one embodiment, the user ID field 1905 can include a randomly generated numerical code, and/or a text string indicating a user. A user ID serves to distinguish a user record associated with a user from a user record associated with other user(s). Although particular examples of identifiers are described herein, other types of identifiers uniquely indicating a user(s) may be utilized without departing from the spirit and scope of the embodiments. Using the example in FIG. 19, ‘Bill1023’ is the user ID associated with the user record 1900.

The user verification code field 1910 includes a verification code for verifying that a user is authorized to access a user record. A user verification code may include a text string and/or numerical code that operate in conjunction with contents of the user ID field 1905 to verify a user authorization(s). In at least one embodiment, a username entered by a user is used to retrieve or “look-up” the user's verification code (password) to compare the verification code with a verification code entered by a user. If both a username match occurs and a verification code match occurs, a user may be allowed to access a user record(s). Other types of security data, such as fingerprint, retinal scan data, etc. may be indicated in the verification code field when technologies such as biometrics are used for access verification without departing from the scope of this disclosure. Using the example illustrated in FIG. 19, the password ‘Billmelater’ is the user verification code associated with the user record 1900 and the user ID ‘Bill023’.

The user communication information field 1915 includes information related to a number of communication channels which have been associated with a user ID. The content of the user communication information field may include a various types of data indicating that a communication service(s) and/or device(s) is associated with a user. For example, a telephone number, an IM credential, an email address, and/or any other information indicating a communication service(s) and/or device(s) which may be associated with a user ID may be indicated in the user channel association field 1915. Using the example illustrated in FIG. 19, the telephone number ‘317.242.2422’, the email address ‘bill1023@chacha.com’, and the IM credential ‘bill1023 AIM’ are associated with the user ID ‘Bill1023’. Any number of communication services and/or devices may be indicated in the user communication information field 1915.

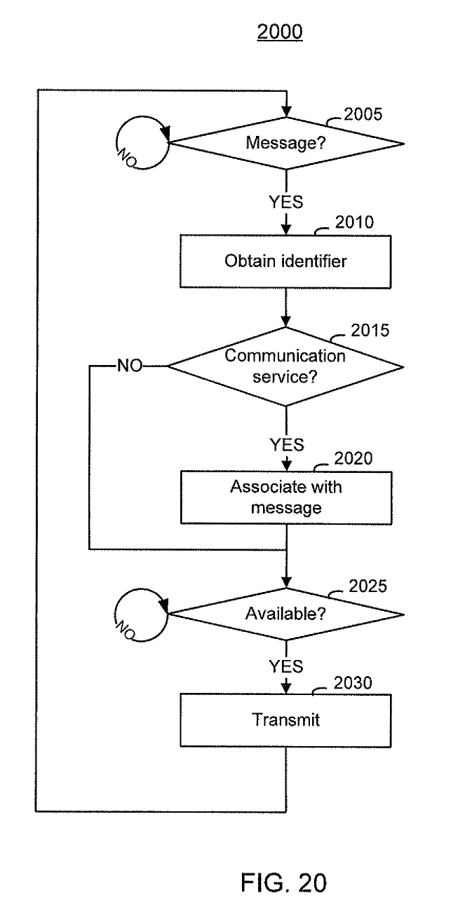

As illustrated in FIG. 20 a process 2000 for associating a communication service(s) with a search request(s) is provided. The process 2000 may be operative on the search system 380 (FIG. 3) and/or any other suitable system such as a server associated with the mobile messaging application 319 (FIG. 3).

In operation 2005 a determination is made as to whether a query (or a message) is received, for example, from a user is received. If in operation 2005 it is determined that a query (or a message) from a user is not received, control remains at operation 2005 and process 2000 continues to wait. If in operation 2005 it is determined that a message from a user is received, control is passed to operation 2010 and process 2000 continues. A message may be based on stored information.

In operation 2010 an identifier associated with a message is obtained. For example, an IP address, a phone number, an email address, an IM credential, a ‘cookie’, a username or any other identifier of a user which is associated with a message may be obtained. Control is passed to operation 2015 and process 2000 continues.

In operation 2015 a determination is made as to whether an additional communication service(s) is associated with a message. If in operation 2015 it is determined that an additional communication service(s) is not associated with a message, control is passed to operation 2025 and process 2000 continues. If in operation 2015 it is determined that an additional communication service(s) is associated a message, control is passed to operation 2020 and process 2000 continues.

The determination in operation 2015 may be based on comparing an identifier associated with a message to information indicated in the database 385 to determine if the identifier is associated with a user ID, which may be associated with a different communication service(s) and/or device(s).

In operation 2020 a communication service(s) is associated with a query (or a message). A communication service(s) may be associated with a search request or other message in various ways. For example, any communication service(s) associated with a user identifier may be associated with a search request so that a user may receive immediate notification of information related to a search request(s) such as a search result(s), or other information. Alternately, a communication service(s) may be selectively associated with a search request based on factors such as a category(ies), a keyword(s), a location, availability information, user selections, or other information which may be indicated in the database 385 (FIG. 3). Using such associations, a user may include information of a communication service(s) which may be utilized to transmit information associated with a search request when a search request is submitted. For example, a user may submit a spoken query, and request to receive a search result via SMS, via a voice reply, and using a webpage provided to a user based on log-in information. In at least one embodiment, a user may designate a default service(s) to be utilized to transmit information related to a search request based on conditions such as a category or keyword associated with a request, a communication service(s) associated with a request, a time factor such as day and date, or a time interval, a priority list for delivering information, etc. Control is passed to operation 2025 and process 2000 continues.

In operation 2025 a determination is made as to whether a search result(s) or other information is available to be transmitted to a user. If in operation 2025 it is determined that a search result(s) or other information is not available to be transmitted to a user control remains at operation 2025 and process 2000 continues to wait. If in operation 2025 it is determined that a search result(s) or other information is available to transmit to a user, control is passed to operation 2030 and process 2000 continues.

In operation 2030 a search result(s) or other information is transmitted to a user. Any information may be transmitted to a user using any communication service(s) associated with a user. For example, a user may receive brief information of a search result(s) via an SMS or text message, and may receive more detailed information of a search result(s) via an internet service. A user may receive a voice message notifying the user that a searcher has been identified and requests clarification relating to a search request. A user may receive an instant message notification that a search result has been provided which may include a link to a website associated with a user. Any or all communication service(s) associated with a search request may be utilized to transmit information to a user. Control is passed to operation 2005 and process 2000 continues.

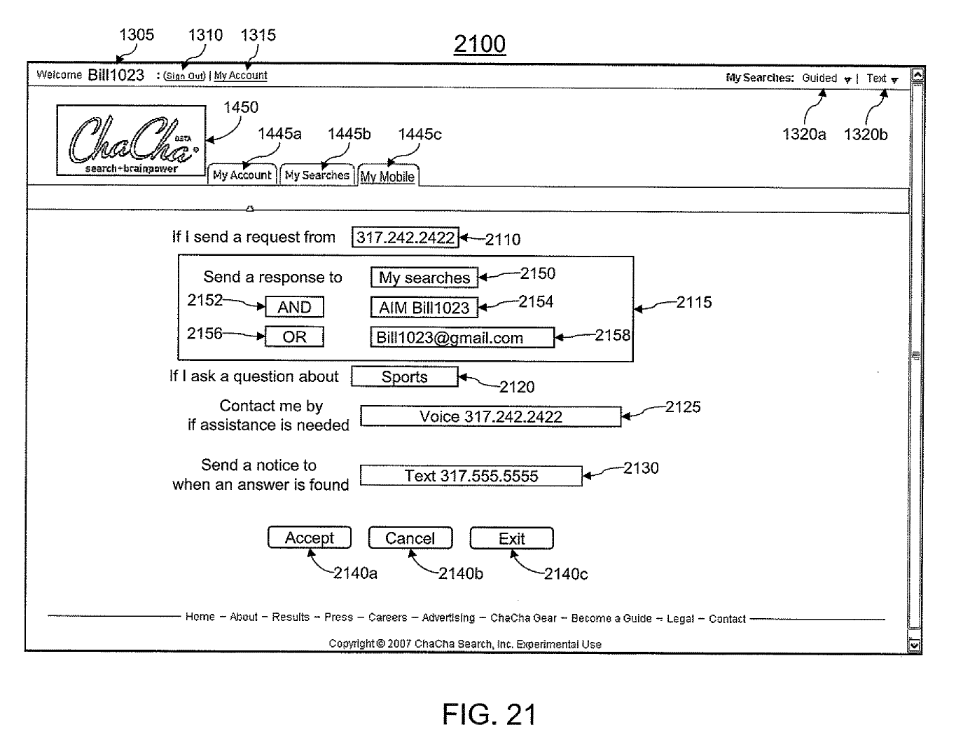

A GUI 2100 for a user to associate a communication service(s) with a search request is illustrated in FIG. 21. The GUI 2100 includes a search condition selector 2110, a search response information window 2115, a search topic selector 2120, a contact indicator 2125, a search notification indicator 2130, and action buttons 2140. The GUI 2100 may be provided to a user and/or a guide.

The search condition selector 2110 may be implemented as a text box, a drop-down list, or typing box, which may present a list of items such as a phone number(s), an email address(es), IM credential(s), user names, locations, or other information. The search condition selector 2110 may be used to designate a condition which will associate one or more communication service(s) with a search request. As illustrated in FIG. 21, a user may designate a location, or a phone number, and email address, etc. from which a search request originates.

The search response window 2115 may be used to indicate a communication service(s) and conditions which may be utilized to send information to a user responsive to a search request associated with the communication service indicated in the search condition selector. The search response window 2115 includes the primary service designator 2150, the first condition designator 2152, the secondary service indicator 2154, the second condition indicator 2156, and the tertiary communication service indicator 2158. The primary service designator 2150 may be implemented as a text box, or preferably a drop-down list of communication services and may indicate a communication service to be used to deliver a search result or other information. The first condition indicator 2152 may be a text box, or drop-down list of conditions, such as ‘AND’, ‘OR’ or other logical conditions which indicate whether and how a secondary communication service may be utilized. The secondary service designator 2154 may be implemented as a text box, or preferably a drop-down list of communication services. The second condition indicator 2156 may be a text box, or drop-down list of conditions, such as ‘AND’, ‘OR’ or other logical conditions which indicate whether and how a tertiary communication service may be utilized. The tertiary service designator 2154 may be implemented as a text box, or preferably a drop-down list of communication services. Although three service designator boxes and two condition indicators are illustrated in FIG. 21, any number of such controls may be provided as needed to operate the embodiments.

The search topic indicator 2120 may be implemented as a text box or drop-down list. The search topic indicator may be used to indicate a category, topic, or other item associated with a search request. For example, a topic such as ‘Sports’, or ‘Dining’ might be indicated using the search topic indicator 2120. For example, if a search request occurs at a particular time of day from a particular device, a response may be delivered using a specified service(s).

The contact indicator 2125 may be a text box, or preferably a drop-down list of communication services associated with a user. The contact indicator 2125 can be used to designate a communication service which may be utilized to communicate with a user to obtain clarification of a search request. For example a user may indicate a telephone number or IM credential which may be utilized for real-time communication with a guide.

The search notification indicator 2130 may be a text box, or preferably a drop-down list of communication services associated with a user. The search notification indicator 2130 may be used to designate a communication service which may be utilized to transmit a notification or other information of a search request to a user.

The action buttons 2140 may be used to take action regarding information obtained using the GUI 2100. The ‘Accept’ button 2140a may be used to indicate that information indicated in the GUI 2100 is to be recorded in the database 385 (FIG. 3). The ‘Cancel’ button 2140b may be used to indicate that information obtained in the GUI 2100 is to be discarded The ‘Exit’ button 2140c may be used to close the GUI 2100.

While the GUI 2100 has been illustrated using specific configurations of controls, and interfaces, any number of controls may be utilized, and any or all of the controls may be suppressed.

A voice, text or other interface may be employed to associate a communication service with a user and/or a search request. For example, a user may associate a communication service with a search request by speaking to a guide, by using a VoiceXML or other voice menu, by sending a text, media, or other mobile message, by sending an email message, etc. The association of a user with a search request may allow any communication service, such as the communication services listed in the user record 1900 illustrated in FIG. 19 to be associated with a search request. A user may designate any communication service to be associated with a search request. A communication service or device may be associated with a search request automatically.

Using the method and system described herein a user of a search system may associate various communication devices and services with a user login ID or other identifier of a user. Using the association of communication device(s) and/or services with a user ID, a user may be provided with information related to search queries that may have been submitted to the search system using any communication service(s) or device(s) which are associated with the user. Likewise a user may obtain information associated with a query using any of the communication services associated with a user ID.

Access to search result(s), guide(s), resource(s) and/or other information associated with a search request(s) may be improved. A guide(s), search result(s) or other information such as an advertisement(s), a game(s), a survey(s), etc. may be targeted to a user based on a communication service(s) which are associated with a user identifier, and/or a communication service(s) and device(s) utilized by a user to access the search system.

A user may receive a search result(s) using any or all communication services associated with a user ID. A user may receive information associated with a search request(s) in an SMS, EMS, or MMS message, in a voice message, in an internet service message, in an email message, in an instant message, in any type of message service(s) and/or a combination of any service(s). The service(s) utilized to submit and to receive information associated with a search request(s) or search result(s) may be determined based on a variety of factors. A user or a search system may automatically associate one or more services with a search request based on a communication service(s) from which a query was submitted, on a location from which a search request originated, on a categorization or keyword(s) of a request, etc. Information associated with a search request may be transmitted to a communication service(s) associated with a user based on various factors. Information of a search request or a search result may be transmitted based on a user being logged-in to the search system, based on an available communication service, based on content of a search request, based on a guide decision, etc.

The many features and advantages of the invention are apparent from the detailed specification and, thus, it is intended by the appended claims to cover all such features and advantages of the invention that fall within the true spirit and scope of the invention. Further, since numerous modifications and changes will be readily perceived by those of ordinary skill in the art, it is not desired to limit the invention to the exact construction and operation illustrated and described, and accordingly all suitable modifications and equivalents may be resorted to while falling within the scope of the invention.

What is claimed is:

1. A method of providing access to information, comprising:
associating a first identifier with a second identifier; and
providing information of a message associated with the first identifier using a service associated with the second identifier.

2. The method of claim 1, wherein the first identifier is a phone number and the second identifier is a login identifier.

3. The method of claim 1, wherein the message is one of an Instant Message, an SMS message, an EMS message, an MMS message, a voice message, an email, or a VoIP call.

4. The method of claim 1, wherein the first identifier is one of a phone number, a user login identifier, an email address, an instant message credential, a persistent cookie, an IP address, a street address or a MAC address.

5. The method of claim 1, wherein the second identifier is one of a phone number, a user login identifier, an email address, an instant message credential, a persistent cookie, an IP address, a street address or a MAC address.

6. The method of claim 1, wherein the service is one of Instant Messaging, SMS, EMS, MMS, a voice service, an email service, a VoIP service, a courier service, or an internet service.

7. The method of claim 1, wherein the message includes a request for information.

8. The method of claim 1, wherein the information includes one of a search request, a search result, an advertisement, a searcher, a resource, a user, a keyword, a category, a location, time, a demographic, a structured query or an advertiser.

9. The method of claim 1, wherein the message is received at a destination associated with a human-assisted search.

10. The method of claim 1, wherein the message is received at a destination associated with an automated search.

11. The method of claim 1, wherein the message is received at a destination associated with an automated search and a human-assisted search.

12. The method of claim 1, wherein the association is done by a person.

13. The method of claim 1, wherein the association is done automatically.

14. The method of claim 1 wherein the information is provided automatically.

15. The method of claim 1, wherein the information is provided using the assistance of a person.

16. The method of claim 1, wherein the information is provided based on a condition.

17. The method of claim 16, wherein the condition is one of a location, time, keyword, category, device status, query status, guide status or user status.

18. A method of providing access to information, comprising:
receiving a search request associated with a telephone number;
associating the telephone number with a login identifier provided by a user; and
providing information of the search request to the user using a web page associated with the login identifier.

19. A computer readable medium storing therein a program for causing a program to execute an operation including providing access to information, comprising:
associating a first identifier with a second identifier; and
providing information of a message associated with the first identifier using a service associated with the second identifier.

20. A system, comprising:
a user device associating a first identifier with a second identifier; and
a search system providing information of a message associated with the first identifier using a service associated with the second identifier.

21. A method of providing information of a search, comprising:
receiving a request using a first communication type; and
conducting a search responsive to the request and providing information resulting from the search using a second communication type.

22. The method of claim 21, wherein the information is formatted for transmission using the second communication type.

23. The method of claim 21, wherein said providing includes determining a preferred communication service of a user submitting the request.

24. The method of claim 24, comprising:
displaying an advertisement having content relevant to the request and selected as being associated with the preferred communication service of the user.

25. The method of claim 21, wherein the information is provided as part of a search service to which a user submitting the request has registered.

26. The method of claim 21, wherein the second communication type among multiple communication types is selected based on a condition designated by a user submitting the request.
